(19) United States
(12) Patent Application Publication
(10) Pub. No.: US 2026/0085256 A1
(43) Pub. Date: Mar. 26, 2026

(54) WASHING MACHINE AND WASHING METHOD

(71) Applicant: Conopco, Inc., d/b/a UNILEVER, Hoboken, NJ (US)

(72) Inventors: Stephen Norman BATCHELOR, Chester, Cheshire (GB); Andrew David GREEN, Dobshill, Flintshire (GB); Clare Anne JONES, Liverpool (GB); David MOORFIELD, Buckley, Flintshire (GB); Alyn James PARRY, Neston, Cheshire (GB)

(73) Assignee: Conopco, Inc., d/b/a UNILEVER, Hoboken, NJ (US)

(21) Appl. No.: 19/110,354

(22) PCT Filed: Aug. 23, 2023
(86) PCT No.: PCT/EP2023/073164

§ 371 Date: Mar. 10, 2025

(30) Foreign Application Priority Data
Sep. 13, 2022 (EP) 22195448.0

(51) Int. Cl. C11D 1/72; C11D 3/37; D06F 35/00; D06F 39/02

(52) U.S. Cl. CPC C11D 1/72; C11D 3/3723; D06F 35/006; D06F 39/022

(57) ABSTRACT

Washing machine comprising a detergent reservoir, said reservoir comprising from 80 ml to 3000 ml liquid detergent comprising C18-containing AE or AES where at least 10% wt. of the AE or AES comprises C18.

The present invention relates to a washing machine and detergent combination.

Despite the prior art there remains a need for improved laundry liquid compositions for use in auto-dosing washing machines.

Accordingly, and in a first aspect, there is provided a washing machine comprising a detergent reservoir, said reservoir comprising from 80 ml to 3000 ml liquid detergent comprising C18-containing AE or AES where at least 10% wt. of the AE or AES comprises C18.

In a second aspect there is provided a method for cleaning fabric comprising filling a reservoir of a washing machine with from 80 ml to 3000 ml of a liquid detergent composition comprising C18-containing AE or AES where at least 10% wt. of the AE or AES comprises C18,
and conducting at least two washing cycles before adding a further liquid detergent to the reservoir.

In a third aspect there is provided a method for cleaning fabric comprising filling a reservoir of a washing machine with from 80 ml to 3000 ml of a liquid laundry detergent composition comprising C18-containing AE or AES where at least 10% wt. of the AE or AES comprises C18, and conducting a washing cycle which draws a portion of the liquid detergent from the reservoir and leaves at least 20 ml in the reservoir.

In a fourth aspect there is provided a method for cleaning a first fabric comprising filling a reservoir of a washing machine with from 80 ml to 3000 ml of a liquid detergent composition comprising C18-containing AE or AES where at least 10% wt. of the AE or AES comprises C18,
and conducting a first washing cycle by forming a first wash liquor in the washing machine by drawing a portion of the liquid detergent from the reservoir and combining with water to form a first wash liquor and washing said first fabric;
optionally rinsing; and removing said first fabric from the washing machine; and
conducting a further wash cycle to clean a further fabric by drawing a portion of the liquid detergent from the reservoir and combining with water to form a further wash liquor and washing said further fabric;
optionally rinsing; and removing said further fabric from the washing machine;
optionally repeating the further wash cycle; and
adding a further liquid detergent to the reservoir.

The amount of 80 ml to 3000 ml liquid detergent characterises an amount of detergent that is more than one dose. Preferably, the reservoir comprises from 250 ml to 2500 ml, more preferably from 400 ml to 2000 ml liquid detergent.

The washing machine preferably comprises a detergent reservoir which is able to store up to 3000 ml of detergent. Such a washing machine is known on the market as an auto-dosing washing machine and is capable of storing sufficient liquid detergent for more than one washing cycle and preferably for many washing cycles. A typical example of such a machine is found in EP-A-3 071 742 (Electrolux). Preferably, the washing machine is a front-loading automatic washing machine.

Preferably, the washing machine comprises an outer casing, a washing tub which is arranged inside the casing with its opening or mouth directly facing a laundry loading/unloading opening realized on a the front wall of the casing, a detergent dispensing assembly which is structured for supplying detergent into the washing tub, a main fresh-water supply circuit which is structured for being connected to the water mains and for selectively channeling a flow of fresh water from the water mains to the detergent dispensing assembly and/or to the washing tub, and an appliance control panel which is structured for allowing the user to manually select the desired washing-cycle.

The washing machine detergent dispensing assembly also comprises an auto-dosing detergent dispenser which is structured for automatically dosing, on the basis of the selected washing cycle, the suitable amount of detergent to be used during the selected washing cycle, and which comprises: one or more detergent reservoirs each of which is structured for receiving a quantity of detergent for performing a plurality of washing cycles; and, for each detergent reservoir, a respective detergent feeding pump which is structured to selectively suck, from the corresponding detergent reservoir, the amount of the detergent for performing the selected washing cycle, and to pump/channel said specific amount of detergent into a detergent collecting chamber fluidly communicating with the washing tub.

As well as the reservoir capable of containing the requisite amount of liquid detergent, the washing machine of the invention comprises a motor to drive the agitation of a drum. Water is flushed through the machine and a pre-determined dose of detergent is added to this water to create the wash liquor.

Using an auto-dosing washing machine a consumer may conduct a number of washing cycles before needing to add further liquid detergent to the reservoir. Typically, a reservoir is sufficient to conduct five or more washes and potentially up to 20 or more depending on the size of the reservoir in the washing machine and also the dose to be used for each washing cycle.

Each washing cycle comprises the drawing of a volume of liquid laundry detergent from the reservoir sufficient to form an appropriate wash liquor to clean the fabric.

Preferably, this volume is from 10 to 75 ml but this is likely dependent on the amount of fabric, the stains to be cleaned and the amount of surfactant and other cleaning agents in the liquid laundry composition.

After the first washing cycle is completed, the remaining liquid detergent is maintained in the washing machine until the next cycle starts, when a further dose is pumped from the reservoir and mixed with water to form a wash liquor.

We have surprisingly found that in such auto-dosing washing machines the liquid detergent is subjected to significant physical stress meaning that some liquid detergents are more suitable for this format than others.

Typical physical stresses include temperature (where the temperature of the interior of the washing machine in the vicinity of the reservoir can easily reach above 50° C. and higher), and agitation due to the washing cycle as well as periods of non-use where the detergent may sit in the reservoir for long periods without any agitation at all.

A further characteristic of liquid detergents in such washing machines is that they must be free flowing when required (i.e. between wash cycles) and must not clog the additional pipework in the auto-dosing apparatus of said washing machine.

It is also necessary that the liquid detergent is satisfactorily preserved during maintenance in the reservoir.

Such conditions are unusual in that it is normal for any liquid to be added to a reservoir at the beginning of the cycle only for it to be flushed out very quickly by the wash water. Accordingly, it is rare for a washing machine to contain more than a single dose of product.

### Surfactant

The liquid detergent of the invention preferably comprises from 2 to 60 wt. % of total surfactant, more preferably from 4 to 50 wt. % and most preferably from 10 to 30% wt. Anionic and non-ionic surfactant are preferred.

The liquid detergent comprising C18-containing AE or AES where at least 10% wt. of the AE or AES comprises C18.

Preferably, the detergent comprises at least 10% wt. of the total alcohol ethoxylate (AE) C18-containing AE. More preferably, the detergent comprises at least 20% wt. of the total AE, C18-containing AE, especially preferably from 30% of the total AE, C18-containing AE and most preferably from 60% of the total AE, C18-containing AE.

Preferably, the detergent comprises at least 10% wt. of the total alcohol ether sulphate (AES) C18-containing AES. More preferably, the detergent comprises at least 20% wt. of the total AES, C18-containing AES, especially preferably from 30% of the total AES, C18-containing AES and most preferably from 60% of the total AES, C18-containing AE.

Anionic surfactants are discussed in the Anionic Surfactants: Organic Chemistry edited by Helmut W. Stache (Marcel Dekker 1995), Surfactant Science Series published by CRC press. Preferred anionic surfactants are sulfonate and sulfate surfactants, preferably alkylbenzene sulphonates, alkyl sulfates and alkyl ether sulfates. The alkyl chain is preferably C10-C18. Alkyl ether sulfates are also called alcohol ether sulfates.

Commonly used in laundry liquid compositions are C12-C18 alkyl ether sulfates having a straight or branched chain alkyl group having 12 to 18 carbon atoms (C12-18) and containing an average of 1 to 3EO units per molecule.

The anionic surfactant is preferably added to the detergent composition in the form of a salt. Preferred cations are alkali metal ions, such as sodium and potassium. However, the salt form of the anionic surfactant may be formed in situ by neutralization of the acid form of the surfactant with alkali such as sodium hydroxide or an amine, such as mono-, di-, or tri-ethanolamine. Weight ratios are calculated for the protonated form of the surfactant.

Non-ionic surfactant are discussed in Non-ionic Surfactants: Organic Chemistry edited by Nico M. van Os (Marcel Dekker 1998), Surfactant Science Series published by CRC press. Preferred non-ionic surfactants are alkoxylate, preferably ethoxylated, Preferred non-ionic surfactant are alcohol ethoxylates and methyl ester ethoxylates, with C10-C18 alkyl chains. Commonly used in laundry liquid compositions are C12-C15 alcohol ethoxylates having a straight or branched chain alkyl group having 12 to 15 carbon atoms and containing an average of 5 to 12EO units per molecule. A preferred example is C12-C15 alcohol ethoxylates with a mole average of 7 to 9 ethoxylate units.

Ethoxy units may be partially replaced by propoxy units in anionic and non-ionic surfactants.

Further examples of suitable anionic surfactants are rhamnolipids, alpha-olefin sulfonates, olefin sulfonates, alkene sulfonates, alkane-2,3-diylbis(sulfates), hydroxyalkanesulfonates and disulfonates, fatty alcohol sulfates (FAS), paraffin sulfonates, ester sulfonates, sulfonated fatty acid glycerol esters, methyl ester sulfonate alkyl- or alkenylsuccinic acid, dodecenyl/tetradecenyl succinic acid (DTSA), fatty acid derivatives of amino acids, DATEM's, CITREM's and diesters and monoesters of sulfo-succinic acid.

Further examples of suitable nonionic surfactants include, alkoxylated fatty acid alkyl esters, alkylpolyglycosides, alkoxylated amines, ethoxylated glycerol esters, fatty acid monoethanolamides, fatty acid diethanolamides, ethoxylated fatty acid monoethanolamides, propoxylated fatty acid monoethanolamides, polyhydroxyalkyl fatty acid amides, or N-acyl N-alkyl derivatives of glucosamine, polysorbates (TWEENS).

The formulation may contain soaps, and zwitterionic or cationic surfactants as minor components, preferably at levels from 0.1 to 3 wt %. Betaines such as CAPB are preferred zwitterionic surfactants.

Preferred non-ionic and anionic surfactants are further described below.

### C18 Alcohol Ethoxylate

The composition comprises at least 10% by weight of the total AE C18AE.

A preferred C18 alcohol ethoxylate is of the formula:

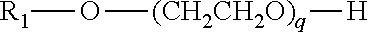

where R₁ is selected from saturated, monounsaturated and polyunsaturated linear C18 alkyl chains and where q is from 4 to 20, preferably 5 to 14, more preferably 8 to 12. The mono-unsaturation is preferably in the 9 position of the chain, where the carbons are counted from the ethoxylate bound chain end. The double bond may be in a cis or trans configuration (oleyl or elaidyl), preferably cis. The cis or trans alcohol ethoxylate CH₃(CH₂)₇—CH═CH—(CH₂)₈O—(OCH₂CH₂)ₙOH, is described as C18:1(L9) alcohol ethoxylate. This follows the nomenclature CX:Y(ΔZ) where X is the number of carbons in the chain, Y is the number of double bonds and ΔZ the position of the double bond on the chain where the carbons are counted from the OH bound chain end.

Preferably, R1 is selected from saturated C18 and monounsaturated C18. Preferably, C16 is also present and, more preferably, the saturated C16 alcohol ethoxylate is at least 90% wt. of the total C16 linear alcohol ethoxylate. As regards the C18 alcohol ethoxylate content, it is preferred that the predominant C18 moiety is C18:1, more preferably C18:1(Δ9). The proportion of monounsaturated C18 alcohol ethoxylate constitutes at least 50% wt. of the total C16 and C18 alcohol ethoxylate surfactant. Preferably, the proportion of monounsaturated C18 constitutes at least 60% wt., most preferably at least 75 of the total C16 and C18 alcohol ethoxylate surfactant.

Preferably, the C16 alcohol ethoxylate surfactant comprises at least 2% wt. and more preferably, from 4% of the total C16 and C18 alcohol ethoxylate surfactant.

Preferably, the saturated C18 alcohol ethoxylate surfactant comprises up to 20% wt. and more preferably, up to 11% of the total C16 and C18 alcohol ethoxylate surfactant.

Preferably the saturated C18 content is at least 2% wt. of the total C16 and C18 alcohol ethoxylate content.

Alcohol ethoxylates are discussed in the Non-ionic Surfactants: Organic Chemistry edited by Nico M. van Os (Marcel Dekker 1998), Surfactant Science Series published by CRC press. Alcohol ethoxylates are commonly referred to as alkyl ethoxylates.

Preferably the weight fraction of C18 alcohol ethoxylate/C16 alcohol ethoxylate is greater than 1, more preferably from 2 to 100, most preferably 3 to 30. ‘C18 alcohol ethoxylate’ is the sum of all the C18 fractions in the alcohol ethoxylate and ‘C16 alcohol ethoxylate’ is the sum of all the C16 fractions in the alcohol ethoxylate.

Linear saturated or mono-unsaturated C20 and C22 alcohol ethoxylate may also be present. Preferably the weight fraction of sum of ‘C18 alcohol ethoxylate’/‘C20 and C22 alcohol ethoxylate’ is greater than 10.

Preferably the C16/18 alcohol ethoxylate contains less than 15 wt %, more preferably less than 8 wt %, most preferably less than 5 wt % of the alcohol ethoxylate polyunsaturated alcohol ethoxylates. A polyunsaturated alcohol ethoxylate contains a hydrocarbon chains with two or more double bonds.

C16/18 alcohol ethoxylates may be synthesised by ethoxylation of an alkyl alcohol, via the reaction:

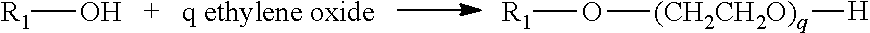

The alkyl alcohol may be produced by transesterification of the triglyceride to a methyl ester, followed by distillation and hydrogenation to the alcohol. The process is discussed in Journal of the American Oil Chemists' Society. 61 (2): 343-348 by Kreutzer, U. R. Preferred alkyl alcohol for the reaction is oleyl alcohol with in an iodine value of 60 to 80, preferably 70 to 75, such alcohol are available from BASF, Cognis, Ecogreen.

Production of the fatty alcohol is further discussed in Sanchez M. A. et al J. Chem. Technol. Biotechnol 2017; 92:27-92 and Ullmann's Enzyclopaedie der technischen Chemie, Verlag Chemie, Weinheim, 4th Edition, Vol. 11, pages 436 et seq.

Preferably the ethoxylation reactions are base catalysed using NaOH, KOH, or NaOCH₃. Even more preferred are catalyst which provide narrower ethoxy distribution than NaOH, KOH, or NaOCH₃. Preferably these narrower distribution catalysts involve a Group II base such as Ba dodecanoate; Group II metal alkoxides; Group II hydrotalcite as described in WO2007/147866. Lanthanides may also be used. Such narrower distribution alcohol ethoxylates are available from Azo Nobel and Sasol.

Preferably the narrow ethoxy distribution has greater than 70 wt. %, more preferably greater than 80 w.t % of the alcohol ethoxylate R—O—(CH₂CH₂O)_{q}—H in the range R—O—(CH₂CH₂O)ₓ—H to R—O—(CH₂CH₂O)_{y}—H where q is the mole average degree of ethoxylation and x and y are absolute numbers, where x=q−q/2 and y=q+q/2. For example when q=10, then greater than 70 wt. % of the alcohol ethoxylate should consist of ethoxylate with 5, 6, 7, 8, 9 10, 11, 12, 13, 14 and 15 ethoxylate groups.

### C18 Alcohol Ether Sulfates

A preferred ether sulfate is of the formula:

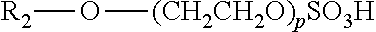

Where R₂ is selected from saturated, monounsaturated and polyunsaturated linear C18 alkyl chains and where p is from 3 to 20, preferably 4 to 12, more preferably 5 to 10. The mono-unsaturation is preferably in the 9 position of the chain, where the carbons are counted from the ethoxylate bound chain end. The double bond may be in a cis or trans configuration (oleyl or elaidyl), but is preferably cis. The cis or trans ether sulfate CH₃(CH₂)₇—CH═CH—(CH₂)₈O—(CH₂CH₂O)ₙSO₃H, is described as C18:1(Δ9) ether sulfate. This follows the nomenclature CX:Y(ΔZ) where X is the number of carbons in the chain, Y is the number of double bonds and ΔZ the position of the double bond on the chain where the carbons are counted from the OH bound chain end.

Preferably, R2 is selected from saturated C18 and monounsaturated C18. More preferably C16 is also present and preferably the saturated C16 is at least 90% wt. of the C16 content linear alkyl. As regards the C18 content, it is preferred that the predominant C18 moiety is C18:1, more preferably C18:1(Δ9). Preferably, the proportion of monounsaturated C18 constitutes at least 50% wt. of the total C16 and C18 alkyl ether sulphate surfactant.

More preferably, the proportion of monounsaturated C18 constitutes at least 60% wt., most preferably at least 75 of the total C16 and C18 alkyl ether sulphate surfactant.

Preferably, the C16 alcohol ethoxylate surfactant comprises at least 2% wt. and more preferably, from 4% of the total C16 and C18 alkyl ether sulphate surfactant.

Preferably, the saturated C18 alkyl ether sulphate surfactant comprises up to 20% wt. and more preferably, up to 11% of the total C16 and C18 alkyl ether sulphate surfactant. Preferably the saturated C18 content is at least 2% wt. of the total C16 and C18 alkyl ether sulphate content.

Where the composition comprises a mixture of the C16/18 sourced material for the alkyl ether sulphate as well as the more traditional C12 alkyl chain length materials it is preferred that the total C16/18 alkyl ether sulphate content should comprise at least 10% wt. of the total alkyl ether sulphate, more preferably at least 50%, even more preferably at least 70%, especially preferably at least 90% and most preferably at least 95% of alkyl ether sulphate in the composition.

Ether sulfates are discussed in the Anionic Surfactants: Organic Chemistry edited by Helmut W. Stache (Marcel Dekker 1995), Surfactant Science Series published by CRC press.

Linear saturated or mono-unsaturated C20 and C22 ether sulfate may also be present. Preferably the weight fraction of sum of ‘C18 ether sulfate’/‘C20 and C22 ether sulfate’ is greater than 10.

Preferably the C16 and C18 ether sulfate contains less than 15 wt. %, more preferably less than 8 wt. %, most preferably less than 4 wt % and most preferably less than 2% wt. of the ether sulfate polyunsaturated ether sulfate. A polyunsaturated ether sulfate contains a hydrocarbon chains with two or more double bonds.

Ether sulfate may be synthesised by the sulphonation of the corresponding alcohol ethoxylate. The alcohol ethoxylate may be produced by ethoxylation of an alkyl alcohol. The alkyl alcohol used to produced the alcohol ethoxylate may be produced by transesterification of the triglyceride to a methyl ester, followed by distillation and hydrogenation to the alcohol. The process is discussed in Journal of the American Oil Chemists' Society. 61 (2): 343-348 by Kreutzer, U. R. Preferred alkyl alcohol for the reaction is oleyl alcohol with an iodine value of 60 to 80, preferably 70 to 75, such alcohol are available from BASF, Cognis, Ecogreen. The degree of polyunsaturation in the surfactant may be controlled by hydrogenation of the triglyceride as described in: A Practical Guide to Vegetable Oil Processing (Gupta M. K. Academic Press 2017). Distillation and other purification techniques may be used.

Ethoxylation reactions are described in Non-Ionic Surfactant Organic Chemistry (N. M. van Os ed), Surfactant Science Series Volume 72, CRC Press.

Preferably the ethoxylation reactions are base catalysed using NaOH, KOH, or NaOCH₃. Even more preferred are catalyst which provide narrower ethoxy distribution than NaOH, KOH, or NaOCH₃. Preferably these narrower distribution catalysts involve a Group II base such as Ba dodecanoate; Group II metal alkoxides; Group II hydrotalcite as described in WO2007/147866. Lanthanides may also be used. Such narrower distribution alcohol ethoxylates are available from Azo Nobel and Sasol.

Preferably the narrow ethoxy distribution has greater than 70 wt. %, more preferably greater than 80 w.t % of the ether sulfate R₂—O—(CH₂CH₂O)ₚSO₃H in the range R₂—O—(CH₂CH₂O)_{z}SO₃H to R₂—O—(CH₂CH₂O)_{w}SO₃H where q is the mole average degree of ethoxylation and x and y are absolute numbers, where z=p−p/2 and w=p+p/2. For example when p=6, then greater than 70 wt. % of the ether sulfate should consist of ether sulfate with 3, 4, 5, 6, 7, 8, 9 ethoxylate groups.

The ether sulfate weight is calculated as the protonated form: R₂—O—(CH₂CH₂O)ₚSO₃H. In the formulation it will be present as the ionic form R₂—O—(CH₂CH₂O)ₚSO₃⁻ with a corresponding counter ion, preferred counter ions are group I and II metals, amines, most preferably sodium.

### Methyl Ester Ethoxylate (MEE)

Preferably, the composition comprises a methyl ester ethoxylate.

A preferred methyl ester ethoxylate surfactant is of the form:

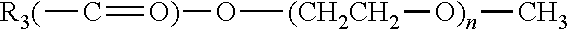

Where R₃COO is a fatty acid moiety, such as oleic, stearic, palmitic. Fatty acid nomenclature is to describe the fatty acid by 2 numbers A:B where A is the number of carbons in the fatty acid and B is the number of double bonds it contains. For example oleic is 18:1, stearic is 18:0 and palmitic 16:0. The position of the double bond on the chain may be given in brackets, 18:1(9) for oleic, 18:2 (9,12) for linoleic where 9 if the number of carbons from the COOH end.

The integer n is the mole average number of ethoxylates.

Methyl Ester Ethoxylates (MEE) are described in chapter 8 of Biobased Surfactants (Second Edition) Synthesis, Properties, and Applications Pages 287-301 (AOCS press 2019) by G. A. Smith; J. Am. Oil. Chem. Soc. vol 74 (1997) page 847-859 by Cox M. E. and Weerasooriva U; Tenside Surf. Det. vol 28 (2001) page by 72-80 by Hreczuch et al; by C. Kolano. Household and Personal Care Today (2012) page 52-55; J. Am. Oil. Chem. Soc. vol 72 (1995) page 781-784 by A. Hama et al. MEE may be produced the reaction of methyl ester with ethylene oxide, using catalysts based on calcium or magnesium. The catalyst may be removed or left in the MEE.

An alternative route to preparation is transesterification reaction of a methyl ester or esterification reaction of a carboxylic acid with a polyethylene glycol that is methyl terminated at one end of the chain.

The methyl ester may be produced by transesterification reaction of methanol with a triglyceride, or esterification reaction of methanol with a fatty acid. Transesterification reactions of a triglyceride to fatty acid methyl esters and glycerol are discussed in Fattah et al (Front. Energy Res., June 2020, volume 8 article 101) and references therein. Common catalysts for these reactions include sodium hydroxide, potassium hydroxide, and sodium methoxide. Esterase and lipases enzyme may also be used. Triglycerides occur naturally in plant fats or oils, preferred sources are rapeseed oil, castor oil, maize oil, cottonseed oil, olive oil, palm oil, safflower oil, sesame oil, soybean oil, high steric/high oleic sunflower oil, high oleic sunflower oil, non-edible vegetable oils, tall oil and any mixture thereof and any derivative thereof. The oil from trees is called tall oil. Used food cooking oils may be utilised. Triglycerides may also be obtained from algae, fungi, yeast or bacteria. Plant sources are preferred.

Distillation and fractionation process may be used in the production of the methyl ester or carboxylic acid to produce the desired carbon chain distribution. Preferred sources of triglyceride are those which contain less than 35% wt polyunsaturated fatty acids in the oil before distillation, fractionation, or hydrogenation.

Fatty acid and methyl ester may be obtained from Oleochemical suppliers such as Wilmar, KLK Oleo, Unilever oleochemical Indonesia. Biodiesel is methyl ester and these sources may be used.

When ESB is MEE preferably has a mole average of from 8 to 30 ethoxylate groups (EO), more preferably from 10 to 20. The most preferred ethoxylate comprises 12 to 18EO.

Preferably, at least 10% wt., more preferably at least 30% wt. of the total C18:1 MEE in the composition has from 9 to 11EO, even more preferably at least 10 wt % is exactly 10EO. For example when the MEE has a mole average of 10EO then at least 10 wt. % of the MEE should consist of ethoxylate with 9, 10 and 11 ethoxylate groups.

The methyl ester ethoxylate preferably has a mole average of from 8 to 13 ethoxylate groups (EO). The most preferred ethoxylate has a mol average of from 9 to 11 EO, even more preferably 10EO. When the MEE has a mole average of 10EO then at least 10 wt. % of the MEE should consist of ethoxylate with 9, 10 and 11 ethoxylate groups.

In the context of the wider MEE contribution, it is preferred that at least 40 wt % of the total MEE in the composition is C18:1.

In addition, it is preferred that the MEE component also comprises some C16 MEE.

Accordingly, it is preferred that the total MEE component comprises from 5 to 50% wt. total MEE, C16 MEE. Preferably the C16 MEE is greater than 90 wt %, more preferably greater than 95 wt % C16:0.

Further, it is preferred that the total MEE component comprises less than 15% wt, more preferably less than 10 wt %, most preferably less than 5 wt % total MEE of polyunsaturated C18, i.e. C18:2 and C18:3. Preferably C18:3 is present at less than 1 wt %, more preferably less than 0.5 wt %, most preferably essentially absent. The levels of polyunsaturation may be controlled by distillation, fractionation or partial hydrogenation of the raw materials (triglyceride or methyl ester) or of the MEE.

Further, it is preferred that the C18:0 component is less than 10 wt % by weight of the total MEE present.

Further, it is preferred that the components with carbon chains of 15 or shorter comprise less than 4 wt % by weight of the total MEE present.

A particularly preferred MEE has 2 to 26 wt. % of the MEE C16:0 chains, 1 to 10 wt. % C18:0 chains, 50 to 85 wt. % C18:1 chains and 1 to 12 wt. % C18:2 chains.

Preferred sources for the alkyl groups for the MEE include methyl ester derived from distilled palm oil and distilled high oleic methyl ester derived from palm kernel oil, partially hydrogenated methyl ester of low euric rapeseed oil, methyl ester of high oleic sunflower oil, methyl ester of high oleic safflower oil and methyl ester of high oleic soybean oil.

High Oleic oils are available from DuPont (Plenish high oleice soybean oil), Monsanto (Visitive Gold Soybean oil), Dow (Omega-9 Canola oil, Omega-9 sunflower oil), the National Sunflower Association and Oilseeds International.

Preferably the double bonds in the MEE are greater than 80 wt % in the cis configuration. Preferably the 18:1 component is oleic. Preferably the 18:2 component is linoleic.

The methyl group of the methyl ester may be replace by an ethyl or propyl group. Methyl is most preferred.

Preferably, the methyl ester ethoxylate comprises from 0.1 to 95% wt. of the composition methyl ester ethoxylate. More preferably the composition comprises from 2 to 40% MEE and most preferably from 4 to 30% wt. MEE.

Preferably, the composition comprises at least 50% wt. water but this depends on the level of total surfactant and is adjusted accordingly.

The composition may comprise further surfactants and preferably other anionic and/or non-ionic surfactants, for example alkyl ether sulphates or alcohol ethoxylates comprising C12 to C18 alkyl chains. In such instances that surfactant sources comprise C18 chains, it is preferred that at least 30% wt of the total C18 surfactant is a methyl ester ethoxylate surfactant.

Preferably the methyl ester ethoxylate surfactant is used in combination with anionic surfactant. Preferably the weight fraction of methyl ester ethoxylate surfactant/total anionic surfactant is from 0.1 to 9, more preferably 0.15 to 2, most preferably 0.2 to 1. By total anionic surfactant means the total content of any of the classes of anionic surfactant preferably ether sulfates, linear alkyl benzene sulfonates, alkyl ether carboxylates, alkyl sulfates, rhamnolipids and mixtures thereof.

Anionic surfactant weights are calculated as the protonated form.

### Sodium Alkyl Sulphate

The composition preferably comprises sodium alkyl sulphate (SAS). The SAS comprises alkyl chains from 10 to 18 carbon atoms in length and which may be straight chained or branched. The alkyl chains may be sourced from renewable sources as described below.

Preferably, the weight average alkyl chain length is from 10 to 14 and is more preferably 12.

The SAS is present in the composition at from 0.1 to 25% wt. of the composition. It is possible that the composition comprises LAS in addition to SAS in which case it is preferred that the SAS comprises from 50% wt (based on protonated forms) of the total LAS plus SAS, more preferably from 70% and most preferably from 95% the total SAS plus LAS.

### Source of Alkyl Chains

The alkyl chain of C16/18 surfactant is preferably obtained from a renewable source, preferably from a triglyceride. A renewable source is one where the material is produced by natural ecological cycle of a living species, preferably by a plant, algae, fungi, yeast or bacteria, more preferably plants, algae or yeasts.

Preferred plant sources of oils are rapeseed, sunflower, maze, soy, cottonseed, olive oil and trees. The oil from trees is called tall oil. Most preferably Palm and Rapeseed oils are the source.

Algal oils are discussed in Energies 2019, 12, 1920 Algal Biofuels: Current Status and Key Challenges by Saad M. G. et al. A process for the production of triglycerides from biomass using yeasts is described in Energy Environ. Sci., 2019, 12, 2717 A sustainable, high-performance process for the economic production of waste-free microbial oils that can replace plant-based equivalents by Masri M. A. et al.

Non edible plant oils may be used and are preferably selected from the fruit and seeds of Jatropha curcas, Calophyllum inophyllum, Sterculia feotida, Madhuca indica (mahua), Pongamia glabra (koroch seed), Linseed, Pongamia pinnata (karanja), Hevea brasiliensis (Rubber seed), Azadirachta indica (neem), Camelina sativa, Lesquerella fendleri, Nicotiana tabacum (tobacco), Deccan hemp, Ricinus communis L. (castor), Simmondsia chinensis (Jojoba), Eruca sativa. L., Cerbera odollam (Sea mango), Coriander (Coriandrum sativum L.), Croton megalocarpus, Pilu, Crambe, syringa, Scheleichera triguga (kusum), Stillingia, Shorea robusta (sal), Terminalia belerica roxb, Cuphea, Camellia, Champaca, Simarouba glauca, Garcinia indica, Rice bran, Hingan (balanites), Desert date, Cardoon, Asclepias syriaca (Milkweed), Guizotia abyssinica, Radish Ethiopian mustard, Syagrus, Tung, Idesia polycarpa var. vestita, Alagae, Argemone mexicana L. (Mexican prickly poppy, Putranjiva roxburghii (Lucky bean tree), Sapindus mukorossi (Soapnut), M. azedarach (syringe), Thevettia peruviana (yellow oleander), Copaiba, Milk bush, Laurel, Cumaru, Andiroba, Piqui, B. napus, Zanthoxylum bungeanum.

### SLES and PAS

SLES and other such alkali metal alkyl ether sulphate anionic surfactants are typically obtainable by sulphating alcohol ethoxylates. These alcohol ethoxylates are typically obtainable by ethoxylating linear alcohols. Similarly, primary alkyl sulphate surfactants (PAS) can be obtained from linear alcohols directly by sulphating the linear alcohol. Accordingly, forming the linear alcohol is a central step in obtaining both PAS and alkali-metal alkyl ether sulphate surfactants.

The linear alcohols which are suitable as an intermediate step in the manufacture of alcohol ethoxylates and therefore anionic surfactants such as sodium lauryl ether sulphate ca be obtained from many different sustainable sources. These include:

### Primary Sugars

Primary sugars are obtained from cane sugar or sugar beet, etc., and may be fermented to form bioethanol. The bioethanol is then dehydrated to form bio-ethylene which then undergoes olefin methathesis to form alkenes. These alkenes are then processed into linear alcohols either by hydroformylation or oxidation.

An alternative process also using primary sugars to form linear alcohols can be used and where the primary sugar undergoes microbial conversion by algae to form triglycerides. These triglycerides are then hydrolysed to linear fatty acids and which are then reduced to form the linear alcohols.

### Biomass

Biomass, for example forestry products, rice husks and straw to name a few may be processed into syngas by gasification. Through a Fischer Tropsch reaction these are processed into alkanes, which in turn are dehydrogenated to form olefins. These olefins may be processed in the same manner as the alkenes described above [primary sugars].

An alternative process turns the same biomass into polysaccharides by steam explosion which may be enzymatically degraded into secondary sugars. These secondary sugars are then fermented to form bioethanol which in turn is dehydrated to form bio-ethylene. This bio-ethylene is then processed into linear alcohols as described above [primary sugars].

### Waste Plastics

Waste plastic is pyrolyzed to form pyrolysed oils. This is then fractioned to form linear alkanes which are dehydrogenated to form alkenes. These alkenes are processed as described above [primary sugars].

Alternatively, the pyrolyzed oils are cracked to form ethylene which is then processed to form the required alkenes by olefin metathesis. These are then processed into linear alcohols as described above [primary sugars].

### Municipal Solid Waste

MSW is turned into syngas by gasification. From syngas it may be processed as described above [primary sugars] or it may be turned into ethanol by enzymatic processes before being dehydrogenated into ethylene. The ethylene may then be turned into linear alcohols by the Ziegler Process.

The MSW may also be turned into pyrolysis oil by gasification and then fractioned to form alkanes. These alkanes are then dehydrogenated to form olefins and then linear alcohols.

### Marine Carbon

There are various carbon sources from marine flora such as seaweed and kelp. From such marine flora the triglycerides can be separated from the source and which is then hydrolysed to form the fatty acids which are reduced to linear alcohols in the usual manner.

Alternatively, the raw material can be separated into polysaccharides which are enzymatically degraded to form secondary sugars. These may be fermented to form bio-ethanol and then processed as described above [Primary Sugars].

### Waste Oils

Waste oils such as used cooking oil can be physically separated into the triglycerides which are split to form linear fatty acids and then linear alcohols as described above.

Alternatively, the used cooking oil may be subjected to the Neste Process whereby the oil is catalytically cracked to form bio-ethylene. This is then processed as described above.

### Methane Capture

Methane capture methods capture methane from landfill sites or from fossil fuel production. The methane may be formed into syngas by gasification. The syngas may be processed as described above whereby the syngas is turned into methanol (Fischer Tropsch reaction) and then olefins before being turned into linear alcohols by hydroformylation oxidation.

Alternatively, the syngas may be turned into alkanes and then olefins by Fischer Tropsch and then dehydrogenation.

### Carbon Capture

Carbon dioxide may be captured by any of a variety of processes which are all well known. The carbon dioxide may be turned into carbon monoxide by a reverse water gas shift reaction and which in turn may be turned into syngas using hydrogen gas in an electrolytic reaction. The syngas is then processed as described above and is either turned into methanol and/or alkanes before being reacted to form olefins.

Alternatively, the captured carbon dioxide is mixed with hydrogen gas before being enzymatically processed to form ethanol. This is a process which has been developed by Lanzatech. From here the ethanol is turned into ethylene and then processed into olefins and then linear alcohols as described above.

The above processes may also be used to obtain the C16/18 chains of the C16/18 alcohol ethoxylate and/or the C16/18 ether sulfates.

### Linear Alkyl Benzene Sulfonate

LAS (linear alkyl benzene sulphonate) is a commonly preferred anionic surfactant.

The key intermediate compound in the manufacture of LAS is the relevant alkene. These alkenes (olefins) may be produced by any of the methods described above and may be formed from primary sugars, biomass, waste plastic, MSW, carbon capture, methane capture, marine carbon to name a few.

Whereas in the processed described above the olefin is processed to form linear alcohols by hydroformylation and oxidation instead, the olefin is reacted with benzene and then sulphonate to form the LAS.

Linear alkylbenzene sulfonates with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain preferably has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ. If used in addition to SAS, linear alkyl benzene sulphonate surfactant is present at from 1 to 20% wt., more preferably from 2 to 15% wt. of the composition, most preferably 8 to 12 wt. %.

### Surfactant Ratios

Preferably, the weight ratio of total non-ionic surfactant to total anionic surfactant (wt. non-ionic/wt. anionic surfactant) is from 0 to 2, preferably from 0.2 to 1.5, most preferably 0.3 to 1.

Preferably, the weight ratio of total non-ionic surfactant to total alkyl ether sulphate surfactant (wt. non-ionic/wt. alkyl ether sulphate) is from 0.5 to 2, preferably from 0.7 to 1.5, most preferably 0.9 to 1.1.

Preferably, the weight ratio of total C16/18 non-ionic surfactant, to total alkyl ether sulphate surfactant (wt. non-ionic/wt. alkyl ether sulphate) is from 0.5 to 2, preferably from 0.7 to 1.5, most preferably 0.9 to 1.1.

Preferably, the weight ratio of total non-ionic surfactant to total C16/18 alkyl ether sulphate surfactant (wt. non-ionic/wt. alkyl ether sulphate) is from 0.5 to 2, preferably from 0.7 to 1.5, most preferably 0.9 to 1.1.

Preferably, the weight ratio of total C18:1 non-ionic surfactant to total C18:1 alkyl ether sulphate surfactant (wt. non-ionic/wt. alkyl ether sulphate) is from 0.5 to 2, preferably from 0.7 to 1.5, most preferably 0.9 to 1.1.

Preferably, the weight ratio of total non-ionic surfactant to linear alkyl benzene sulphonate, where present, (wt. non-ionic/wt. linear alkyl benzene sulphonate) is from 0.1 to 2, preferably 0.3 to 1, most preferably 0.45 to 0.85.

Preferably, the weight ratio of total C16/18 non-ionic surfactant to linear alkyl benzene sulphonate, where present, (wt. non-ionic/wt. linear alkyl benzene sulphonate) is from 0.1 to 2, preferably 0.3 to 1, most preferably 0.45 to 0.85.

Preferably, the composition is visually clear.

### Liquid Laundry Detergents

The term “laundry detergent” in the context of this invention denotes formulated compositions intended for and capable of wetting and cleaning domestic laundry such as clothing, linens and other household textiles. The object of the invention is to provide a composition which on dilution is capable of forming a liquid laundry detergent composition and in the manner now described.

In a preferred embodiment the liquid composition is isotropic.

The term “linen” is often used to describe certain types of laundry items including bed sheets, pillow cases, towels, tablecloths, table napkins and uniforms. Textiles can include woven fabrics, non-woven fabrics, and knitted fabrics; and can include natural or synthetic fibres such as silk fibres, linen fibres, cotton fibres, polyester fibres, polyamide fibres such as nylon, acrylic fibres, acetate fibres, and blends thereof including cotton and polyester blends.

Examples of liquid laundry detergents include heavy-duty liquid laundry detergents for use in the wash cycle of automatic washing machines, as well as liquid fine wash and liquid colour care detergents such as those suitable for washing delicate garments (e.g. those made of silk or wool) either by hand or in the wash cycle of automatic washing machines.

The term “liquid” in the context of this invention denotes that a continuous phase or predominant part of the composition is liquid and that the composition is flowable at 15° C. and above. Accordingly, the term “liquid” may encompass emulsions, suspensions, and compositions having flowable yet stiffer consistency, known as gels or pastes. The viscosity of the composition is preferably from 200 to about 10,000 mPa·s at 25° C. at a shear rate of 21 sec⁻¹. This shear rate is the shear rate that is usually exerted on the liquid when poured from a bottle. Pourable liquid detergent compositions preferably have a viscosity of from 200 to 1,500 mPa·s, preferably from 200 to 700 mPa·s.

A composition according to the invention may suitably have an aqueous continuous phase. By “aqueous continuous phase” is meant a continuous phase which has water as its basis. Preferably, the composition comprises at least 50% wt. water and more preferably at least 70% wt. water.

The alkyl ether sulfate may be provided in a single raw material component or by way of a mixture of components.

Where the composition comprises a mixture of the C16/18 sourced material for the alkyl ether sulphate as well as the more traditional C12 alkyl chain length materials it is preferred that the C16/18 alkyl ether sulphate should comprise at least 10% wt. of the total alkyl ether sulphate, more preferably at least 50%, even more preferably at least 70%, especially preferably at least 90% and most preferably at least 95% of alkyl ether sulphate in the composition.

The alcohol ethoxylate may be provided in a single raw material component or by way of a mixture of components.

Where the composition comprises a mixture of the C16/18 sourced material for the alcohol ethoxylate as well as the more traditional C12 alkyl chain length materials it is preferred that the C16/18 alcohol ethoxylate should comprise at least 10% wt. total alcohol ethoxylate, more preferably at least 50%, even more preferably at least 70%, especially preferably at least 90% and most preferably at least 95% of the alcohol ethoxylate in the composition.

Preferably, the selection and amount of surfactant is such that the composition and the diluted mixture are isotropic in nature.

The composition comprises one of:
polyamines
aminocarboxylate sequestrant;
external structurant;
C18-containing AE or AES where at least 10% wt. of the AE or AES comprises C18.

Preferably, the composition comprises two, and more preferably three of:
polyamines
aminocarboxylate sequestrant;
external structurant;
C18-containing AE or AES where at least 10% wt. of the AE or AES comprises C18.

Most preferably, the composition comprises all four.

### Polyamine

Preferably, the composition comprises a polyamine as an anti-redeposition polymer to stabilize the soil in the wash solution thus preventing redeposition of the soil. Suitable soil release polymers for use in the invention include alkoxylated polyamine, preferably alkoxylated polyethyleneimines. Polyethyleneimines are materials composed of ethylene imine units —CH₂CH₂NH— and, where branched, the hydrogen on the nitrogen is replaced by another chain of ethylene imine units. Preferred alkoxylated polyethyleneimines for use in the invention have a polyethyleneimine backbone of about 300 to about 10000 weight average molecular weight (M_{w}). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25 alkoxy groups per modification. A preferred material is ethoxylated polyethyleneimine, with an average degree of ethoxylation being from 10 to 30, preferably from 15 to 25 ethoxy groups per ethoxylated nitrogen atom in the polyethyleneimine backbone.

Mixtures of any of the above-described materials may also be used.

More preferably, the polyamine is an alkoxylated cationic or zwitterionic di or polyamine polymer, wherein the positive charge is provided by quaternisation of the nitrogen atoms of the amines, and the anionic groups (where present) by sulphation or sulphonation of the alkoxylated group.

Preferably the alkoxylate is selected from propoxy and ethoxy, most preferably ethoxy.

Preferably greater than or equal to 50 mol % of nitrogen amines are quaternised, preferably with a methyl group. Preferably the polymer contains 2 to 10, more preferably 2 to 6, most preferably 3 to 5 quaternised nitrogen amines. Preferably the alkoxylate groups are selected from ethoxy and propoxy groups, most preferably ethoxy.

Preferably the polymer contains ester (COO) or acid amide (CONH) groups within the structure, preferably these groups are placed, so that when all the ester or acid amide groups are hydrolysed, at least one, preferably all of the hydrolysed fragments has a molecular weight of less than 4000, preferably less than 2000, most preferably less than 1000.

Preferably the polymer is of the form:

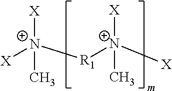

Where R₁ is a C₃ to C₈ alkyl group, X is an a (C₂H₄O)nY group where n is from 15 to 30, where m is from 2 to 10, preferably 2, 3, 4 or 5 and where Y is selected from OH and SO₃⁻ and preferably the number of SO₃⁻ groups is greater than the number of OH groups. Preferably there are from 0, 1 or 2 OH groups. X and R₁ may contain ester groups within them. X may contain a carbonyl group, preferably an ester group. There is preferably 1 C₂H₄O unit separating the ester group from the N, such that the structural unit N—C₂H₄O-ester-(C₂H₄O)ₙ₋₁Y is preferred.

Such polymers are described in WO2021239547 (Unilever), An example polymer is sulphated ethoxylated hexamethylene diamine and examples P1, P2, P3, P4, P5 and P6 of WO2021239547. Acid amide and ester groups may be included using lactones or sodium chloroacetate respectively (Modified Williamson synthesis), addition to an OH or NH group, then subsequent ethoxylation.

An example reaction scheme for inclusion of an ester group is

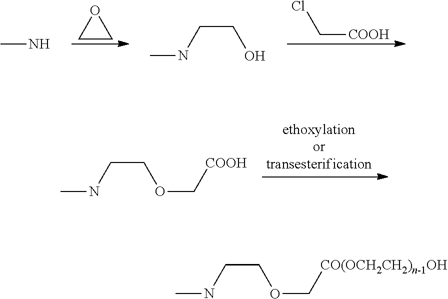

Addition of lactones is discussed in WO2021/165468.

A composition of the invention will preferably comprise from 0.025 to 8% wt. of one or more anti-redeposition polymers such as, for example, the alkoxylated polyethyleneimines or zwitterionic polyamines which are described above.

### Aminocarboxylate Sequestrants

Preferably, the aminocarboxylate is selected from GLDA and MGDA.

Preferably the aminocarboxylate is present in the composition at from 0.1 to 15% wt., more preferably 0.1 to 10% wt., even more preferably 0.3 to 5% wt., still more preferably 0.8 to 3% wt., and most preferably 1 to 2.5% wt. (by weight of the composition).

### Glutamic Acid Diacetic Acid (GLDA)

GLDA may be present as a salt or a mixture of GDLA and a GDLA salt. Preferred salt forms include mono-, di-, tri- or tetraalkali metal and mono-, di-, tri- or tetraammonium salts of GLDA. Alkali metal salts of glutamic acid diacetic acid GDLA are preferably selected from lithium salts, potassium salts and more preferably sodium salts of GLDA.

Glutamic acid diacetic acid can be partially or preferably fully neutralized with the respective alkali. Preferably, an average of from 3.5 to 4 COOH groups of GLDA is neutralized with alkali metal, preferably with sodium. Most preferably the composition comprises a tetrasodium salt of GLDA.

GLDA is at least partially neutralized with alkali metal, more preferably with sodium or potassium, most preferred with sodium.

The GLDA salt may be an alkali metal salt of L-GLDA, an alkali metal salt of D-GLDA, or enantiomerically enriched mixtures of isomers.

Preferably the composition comprises a mixture of L- and D-enantiomers of glutamic acid diacetic acid (GLDA) or its respective mono-, di-, tri-, or tetraalkali metal or mono-, di-, tri- or tetraammonium salt or mixtures thereof, said mixtures containing predominantly the respective L-isomer with an enantiomeric excess in the range of from 10 to 95%.

Preferably the GLDA salt is essentially L-glutamic acid diacetic acid that is at least partially neutralized with alkali metal.

Sodium salts of GLDA are preferred.

A suitable commercial source of GLDA in the form of the tetrasodium salt is DISSOLVINE® GL available from Nouryon.

Preferably the GLDA is present in the composition at from 0.1 to 15% wt., more preferably 0.1 to 10% wt., even more preferably 0.3 to 5% wt., still more preferably 0.8 to 3% wt., and most preferably 1 to 2.5% wt. (by weight of the composition).

### Methyl Glycine Diacetic Acid (MGDA)

Preferred salt forms include mono-, di-, tri- or tetraalkali metal and mono-, di-, tri- or tetraammonium salts of MGDA. Alkali metal salts are preferably selected from lithium salts, potassium salts and more preferably sodium salts of MGDA.

The sodium salt of methyl glycine diacetic acid is preferred. Especially preferred is the tri-sodium salt of MGDA.

MGDA can be partially or preferably fully neutralized with the respective alkali metal. Preferably, an average of from 2.7 to 3 COOH groups per molecule of MGDA is neutralized with alkali metal, preferably with sodium.

MGDA can be selected from racemic mixtures of alkali metal salts of MGDA and of the pure enantiomers such as alkali metal salts of L-MGDA, alkali metal salts of D-MGDA and of mixtures of enantiomerically enriched isomers.

Suitable commercial sources of MGDA in the form of the trisodium salt are TRILON® M available from BASF and Dissolvine® M-40 from Nouryon.

Preferably the MGDA is present in the composition at from 0.1 to 15% wt., more preferably 0.1 to 10% wt., even more preferably 0.3 to 5% wt., still more preferably 0.8 to 3% wt., and most preferably 1 to 2.5% wt. (by weight of the composition).

Minor amounts of the aminocarboxylate may bear a cation other than alkali metal. It is thus possible that minor amounts, such as 0.01 to 5 mol-% bear alkali earth metal cations such as Mg2+ or Ca2+, or an Fe(II) or Fe(III) cation. GLDA may contain minor amounts of impurities stemming from its synthesis, such as lactic acid, alanine, propionic acid or the like. “Minor amounts” in this context refer to a total of 0.1 to 1% by weight, referring to sequestering agent aminocarboxylate.

In addition to the aminocarboxylate sequestrant the detergent compositions may also optionally contain relatively low levels of organic detergent builder or sequestrant material. Examples include the alkali metal, citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids, and citric acid. Other examples are DEQUEST™, organic phosphonate type sequestering agents sold by Monsanto and alkanehydroxy phosphonates.

Other suitable organic builders include the higher molecular weight polymers and copolymers known to have builder properties. For example, such materials include appropriate polyacrylic acid, polymaleic acid, and polyacrylic/polymaleic acid copolymers and their salts, for example those sold by BASF under the name SOKALAN™. If utilized, the organic builder materials may comprise from about 0.5 percent to 20 wt percent, preferably from 1 wt percent to 10 wt percent, of the composition. The preferred builder level is less than 10 wt percent and preferably less than 5 wt percent of the composition. More preferably the liquid laundry detergent formulation is a non-phosphate built laundry detergent formulation, i.e., contains less than 1 wt. % of phosphate. Most preferably the laundry detergent formulation is not built i.e. contain less than 1 wt. % of builder. Generally in liquids, a preferred sequestrant is HEDP (1-Hydroxyethylidene-1,1,-diphosphonic acid), for example sold as Dequest 2010. Also suitable but less preferred as it gives inferior cleaning results is Dequest® 2066 (Diethylenetriamine penta(methylene phosphonic acid or Heptasodium DTPMP). However, it is preferred that the composition comprises less than 0.5% wt. phosphonate based sequestrant and more preferably less than 0.1% wt. phosphonate based sequestrant. Most preferably, the composition is free from phosphonate based sequestrant.

### External Structurants

Compositions of the invention may have their rheology further modified by use of one or more external structurants which form a structuring network within the composition. Examples of such materials include crystallizable glycerides such as hydrogenated castor oil; microfibrous cellulose and citrus pulp fibre. The presence of an external structurant may provide shear thinning rheology and may also enable materials such as encapsulates and visual cues to be suspended stably in the liquid.

The composition preferably comprises a crystallizable glyceride.

The crystallizable glyceride is useful in forming an external structuring system as described in WO2011/031940, the contents of which, in particular as regards manufacture of the ESS are incorporated by reference. Where an ESS is present it is preferred that the ESS of the present invention preferably comprises: (a) crystallizable glyceride(s); (b) alkanolamine; (c) anionic surfactant; (d) additional components; and (e) optional components. Each of these components is discussed in detail below.

Crystallizable glyceride(s) of use herein preferably include “Hydrogenated castor oil” or “HCO”. HCO as used herein most generally can be any hydrogenated castor oil, provided that it is capable of crystallizing in the ESS premix. Castor oils may include glycerides, especially triglycerides, comprising C10 to C22 alkyl or alkenyl moieties which incorporate a hydroxyl group. Hydrogenation of castor oil to make HCO converts double bonds, which may be present in the starting oil as ricinoleyl moieties, to convert ricinoleyl moieties to saturated hydroxyalkyl moieties, e.g., hydroxystearyl. The HCO herein may, in some embodiments, be selected from: trihydroxystearin; dihydroxystearin; and mixtures thereof. The HCO may be processed in any suitable starting form, including, but not limited those selected from solid, molten and mixtures thereof. HCO is typically present in the ESS of the present invention at a level of from about 2 percent to about 10 percent, from about 3 percent to about 8 percent, or from about 4 percent to about 6 percent by weight of the structuring system. In some embodiments, the corresponding percentage of hydrogenated castor oil delivered into a finished laundry detergent product is below about 1.0 percent, typically from 0.1 percent to 0.8 percent.

Useful HCO may have the following characteristics: a melting point of from about 40 degrees centigrade to about 100 degrees centigrade, or from about 65 degrees centigrade to about 95 degrees C.; and/or Iodine value ranges of from 0 to about 5, from 0 to about 4, or from 0 to about 2.6. The melting point of HCO can measured using either ASTM D3418 or ISO 11357; both tests utilize DSC: Differential Scanning Calorimetry. HCO of use in the present invention includes those that are commercially available. Non-limiting examples of commercially available HCO of use in the present invention include:

THIXCIN® from Rheox, Inc. Further examples of useful HCO may be found in U.S. Pat. No. 5,340,390. The source of the castor oil for hydrogenation to form HCO can be of any suitable origin, such as from Brazil or India. In one suitable embodiment, castor oil is hydrogenated using a precious metal, e.g., palladium catalyst, and the hydrogenation temperature and pressure are controlled to optimize hydrogenation of the double bonds of the native castor oil while avoiding unacceptable levels of dehydroxylation.

The invention is not intended to be directed only to the use of hydrogenated castor oil. Any other suitable crystallizable glyceride(s) may be used. In one example, the structurant is substantially pure triglyceride of 12-hydroxystearic acid. This molecule represents the pure form of a fully hydrogenated triglyceride of 12-hydrox-9-cis-octadecenoic acid. In nature, the composition of castor oil is rather constant, but may vary somewhat. Likewise hydrogenation procedures may vary. Any other suitable equivalent materials, such as mixtures of triglycerides wherein at least 80 percent wt. is from castor oil, may be used. Exemplary equivalent materials comprise primarily, or consist essentially of, triglycerides; or comprise primarily, or consist essentially of, mixtures of diglycerides and triglycerides; or comprise primarily, or consist essentially of, mixtures of triglyerides with diglycerides and limited amounts, e.g., less than about 20 percent wt. of the glyceride mixtures, of monoglyerides; or comprise primarily, or consist essentially of, any of the foregoing glycerides with limited amounts, e.g., less than about 20 percent wt., of the corresponding acid hydrolysis product of any of said glycerides. A proviso in the above is that the major proportion, typically at least 80 percent wt, of any of said glycerides is chemically identical to glyceride of fully hydrogenated ricinoleic acid, i.e., glyceride of 12-hydroxystearic acid. It is for example well known in the art to modify hydrogenated castor oil such that in a given triglyceride, there will be two 12-hydroxystearic-moieties and one stearic moiety. Likewise it is envisioned that the hydrogenated castor oil may not be fully hydrogenated. In contrast, the invention excludes poly(oxyalkylated) castor oils when these fail the melting criteria.

Crystallizable glyceride(s) of use in the present invention may have a melting point of from about 40 degrees centigrade to about 100 degrees centigrade.

### Hydroxymate

Preferably, the composition comprises hydroxamate.

Whenever either the term ‘hydroxamic acid’ or ‘hydroxamate’ is used, this encompasses both hydroxamic acid and the corresponding hydroxamate (salt of hydroxamic acid), unless indicated otherwise.

Hydroxamic acids are a class of chemical compounds in which a hydroxylamine is inserted into a carboxylic acid. The general structure of a hydroxamic acid is the following:

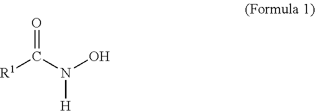

in which R¹ is an organic residue, for example alkyl or alkylene groups. The hydroxamic acid may be present as its corresponding alkali metal salt, or hydroxamate. The preferred salt is the potassium salt.

The hydroxamates may conveniently be formed from the corresponding hydroxamic acid by substitution of the acid hydrogen atom by a cation:

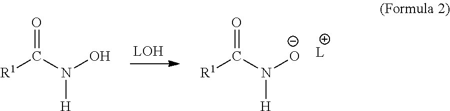

L* is a monovalent cation for example the alkali metals (e.g. potassium, sodium), or ammonium or a substituted ammonium.

In the present invention the hydroxamic acid or its corresponding hydroxamate has the structure:

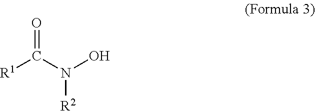

wherein R¹ is
a straight or branched C₄-C₂₀ alkyl, or
a straight or branched substituted C₄-C₂₀ alkyl, or
a straight or branched C₄-C₂₀ alkenyl, or
a straight or branched substituted C₄-C₂₀ alkenyl, or
an alkyl ether group CH₃(CH₂)ₙ(EO)ₘ wherein n is from 2 to 20 and m is from 1 to 12, or
a substituted alkyl ether group CH₃(CH₂)ₙ(EO)ₘ wherein n is from 2 to 20 and m is from 1 to 12, and the types of substitution include one or more of NH₂, OH, S, —O— and COOH,
and R² is selected from hydrogen and a moiety that forms part of a cyclic structure with a branched R¹ group.

The preferred hydroxamates are those where R² is Hydrogen and R¹ is C8 to C₁₄ alkyl, preferably normal alkyl, most preferably saturated.

The general structure of a hydroxamic acid in the context of the present invention has been indicated in formula 3, and R¹, is as defined above. When R¹ is an alkyl ether group CH₃(CH₂)ₙ(EO)ₘ wherein n is from 2 to 20 and m is from 1 to 12 then the alkyl moiety terminates this side group. Preferably, R¹ is chosen from the group consisting of C₄, C₅, C₆, C₇, C₈, C₉, C₁₀, C₁₁, C₁₂ and C₁₄ normal alkyl group, most preferably R¹ is at least a C₈₋₁₄ normal alkyl group. When the C₈ material is used this is called octyl hydroxamic acid. The potassium salt is particularly useful.

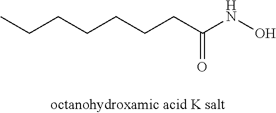

However, other hydroxamic acids, whilst less preferred, are suitable for use in the present invention. Such suitable compounds include, but are not limited to, the following compounds: Such hydroxamic acids include lysine hydroxamate HCl, methionine hydroxamate and norvaline hydroxamate and are commercially available.

The hydroxamate is thought to act by binding to metal ions that are present in the soil on the fabric. This binding action, which is, in effect, the known sequestrant property of the hydroxamate is not, in itself, of any use to remove the soil from the fabric. The key is the “tail” of the hydroxamate i.e. the group R¹ minus any branching that folds back onto the amate nitrogen via group R². The tail is selected to have an affinity for the surfactant system. This means that the soil removal ability of an already optimised surfactant system is further enhanced by the use of the hydroxamate as it, in effect, labels the difficult to remove particulate material (clay) as “soil” for removal by the surfactant system acting on the hydroxamate molecules now fixed to the particulates via their binding to the metal ions embedded in the clay type particulates. The non-soap detersive surfactants will adhere to the hydroxamate, leading overall to more surfactants interacting with the fabric, leading to better soil release. Therewith the hydroxamic acids act as a linker molecule facilitating the removal and suspension of the particulate soil from the fabric into a wash liquor and thus boosting the primary detergency.

The hydroxamates have a higher affinity for transition metals, like iron, than for alkaline earth metals, for example calcium and magnesium, therefore the hydroxamic acid primarily acts to improve the removal of soil on fabric, especially particulate soils, and not additionally as a builder for calcium and magnesium.

A preferred hydroxamate is the 80 percent solids coco hydroxamic acid available under the trade name RK853 from Axis House. The corresponding Potassium salt is available from Axis House under the trade name RK852. Axis house also supply the coco hydroxamic acid as a 50 percent solids material under the trade name RK858. The 50 percent coco hydroxamate potassium salt is available as RK857. Another preferred material is RK842, an Alkyl hydroxamic acid made from Palm Kernel Oil, from Axis House.

Preferably, the hydroxamate is present at from 0.1 to 3% wt. of the composition, more preferably from 0.2 to 2% wt of the composition.

Preferably, the weight ratio between the hydroxamate and the surfactant is from 0.05 to 0.3, more preferably from 0.75 to 0.2 and most preferably from 0.8 to 1.2. Weights are calculated based on the protonated forms.

### Alkoxylated Cationic or Zwitterionic Polyamine Polymer

Preferably, the composition comprises an alkoxylated cationic or zwitterionic polyamine polymer. Preferably, the polyamine is an alkoxylated cationic or zwitterionic di or polyamine polymer, wherein the positive charge is provided by quaternisation of the nitrogen atoms of the amines, and the anionic groups (where present) by sulphation or sulphonation of the alkoxylated group.

Preferably the alkoxylate is selected from propoxy and ethoxy, most preferably ethoxy.

Preferably greater than or equal to 50 mol % of nitrogen amines are quaternised, preferably with a methyl group. Preferably the polymer contains 2 to 10, more preferably 2 to 6, most preferably 3 to 5 quanternised nitrogen amines. Preferably the alkoxylate groups are selected from ethoxy and propoxy groups, most preferably ethoxy.

Preferably the polymer contains ester (COO) or acid amide (CONH) groups within the structure, preferably these groups are placed, so that when all the ester or acid amide groups are hydrolysed, at least one, preferably all of the hydrolysed fragments has a molecular weight of less than 4000, preferably less than 2000, most preferably less than 1000.

Preferably the polymer is of the form:

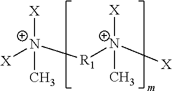

Where R₁ is a C₃ to C₈ alkyl group, X is an a (C₂H₄O)nY group where n is from 15 to 30, where m is from 2 to 10, preferably 2, 3, 4 or 5 and where Y is selected from OH and SO₃⁻ and preferably the number of SO₃⁻ groups is greater than the number of OH groups. Preferably there are from 0, 1 or 2 OH groups. X and R₁ may contain ester groups within them. X may contain a carbonyl group, preferably an ester group. There is preferably 1 C₂H₄O unit separating the ester group from the N, such that the structural unit N— C₂H₄O-ester-(C₂H₄O)ₙ₋₁Y is preferred.

Such polymers are described in WO2021239547 (Unilever), An example polymer is sulphated ethoxylated hexamethylene diamine and examples P1, P2, P3, P4, P5 and P6 of WO2021239547. Ester groups may be included using lactones or sodium chloroacetate (Modified Williamson synthesis), addition to an OH or NH group, then subsequent ethoxylation.

### Enzymes

The composition preferably comprises an enzyme selected from cellulase, a protease and an amylase/mannase mixture.

In addition, further enzymes may be present such as those described below.

Preferably, the composition may comprise an effective amount of one or more enzyme preferably selected from the group comprising lipases, hemicellulases, peroxidases, hemicellulases, xylanases, xantanase, lipases, phospholipases, esterases, cutinases, pectinases, carrageenases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, tannases, nucleases (such as deoxyribonuclease and/or ribonuclease), phosphodiesterases, or mixtures thereof.

Preferably the level of an enzyme is from 0.1 to 100, more preferably from 0.5 to 50, most preferably from 5 to 30 mg active enzyme protein per 100 g finished laundry liquid composition.

Examples of preferred enzymes are sold under the following trade names Purafect Prime®, Purafect®, Preferenz® (DuPont), Savinase®, Pectawash®, Mannaway®, Lipex®, Lipoclean®, Whitzyme® Stainzyme®, Stainzyme Plus®, Natalase®, Mannaway®, Amplify® Xpect®, Celluclean® (Novozymes), Biotouch (AB Enzymes), Lavergy® (BASF).

Detergent enzymes are discussed in WO2020/186028 (Procter and Gamble), WO2020/200600 (Henkel), WO2020/070249 (Novozymes), WO2021/001244 (BASF) and WO2020/259949 (Unilever).

A nuclease enzyme is an enzyme capable of cleaving the phosphodiester bonds between the nucleotide sub-units of nucleic acids and is preferably a deoxyribonuclease or ribonuclease enzyme. Preferably the nuclease enzyme is a deoxyribonuclease, preferably selected from any of the classes E.C. 3.1.21.x, where x=l, 2, 3, 4, 5, 6, 7, 8 or 9, E.C. 3.1.22.y where y=l, 2, 4 or 5, E.C. 3.1.30.Z where z=1 or 2, E.C. 3.1.31.1 and mixtures thereof.

Protease enzymes hydrolyse bonds within peptides and proteins, in the laundry context this leads to enhanced removal of protein or peptide containing stains. Examples of suitable proteases families include aspartic proteases; cysteine proteases; glutamic proteases; aspargine peptide lyase; serine proteases and threonine proteases. Such protease families are described in the MEROPS peptidase database (http://merops.sanger.ac.uk/). Serine proteases are preferred. Subtilase type serine proteases are more preferred. The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub divisions, i.e. the Subtilisin family, the Thermitase family, the Proteinase K family, the Lantibiotic peptidase family, the Kexin family and the Pyrolysin family.

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO 89/06279 and protease PD138 described in (WO 93/18140). Other useful proteases may be those described in WO 92/175177, WO 01/016285, WO 02/026024 and WO 02/016547. Examples of trypsin-like proteases are trypsin (e.g. of porcine or bovine origin) and the Fusarium protease described in WO 89/06270, WO 94/25583 and WO 05/040372, and the chymotrypsin proteases derived from Cellumonas described in WO 05/052161 and WO 05/052146.

Most preferably the protease is a subtilisins (EC 3.4.21.62).

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO89/06279 and protease PD138 described in (WO93/18140). Preferably the subsilisin is derived from Bacillus, preferably Bacillus lentus, B. alkalophilus, B. subtilis, B. amyloliquefaciens, Bacillus pumilus and Bacillus gibsonii as described in U.S. Pat. No. 6,312,936 BI, U.S. Pat. Nos. 5,679,630, 4,760,025, 7,262,042 and WO 09/021867. Most preferably the subtilisin is derived from Bacillus gibsonii or Bacillus Lentus.

Suitable commercially available protease enzymes include those sold under the trade names names Alcalase®, Blaze®; Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® all could be sold as Ultra® or Evity® (Novozymes A/S).

Suitable amylases (alpha and/or beta) include those of bacterial or fungal origin. Chemically modified or protein engineered mutants are included. Amylases include, for example, alpha-amylases obtained from Bacillus, e.g. a special strain of B. licheniformis, described in more detail in GB 1,296,839, or the Bacillus sp. strains disclosed in WO 95/026397 or WO00/060060. Commercially available amylases are Duramyl™, Termamyl™, Termamyl Ultra™, Natalase™, Stainzyme™, Fungamyl™ and BAN™ (Novozymes A/S), Rapidase™ and Purastar™ (from Genencor International Inc.).

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Thielavia terrestris, Myceliophthora thermophila, and Fusarium oxysporum disclosed in U.S. Pat. Nos. 4,435,307, 5,648,263, 5,691,178, 5,776,757, WO 89/09259, WO 96/029397, and WO 98/012307. Commercially available cellulases include Celluzyme™, Carezyme™, Celluclean™, Endolase™, Renozyme™ (Novozymes A/S), Clazinase™ and Puradax HA™ (Genencor International Inc.), and KAC-500(B)™ (Kao Corporation). Celluclean™ is preferred.

### Lipase

Preferably, the composition comprises a lipase.

Lipases are lipid esterase enzymes and the terms lipid esterase and lipase are used herein synonymously.

The composition preferably comprises from 0.0005 to 0.5 wt. %, preferably from 0.005 to 0.2 wt. % of a lipase.

Cleaning lipid esterases are discussed in Enzymes in Detergency edited by Jan H. Van Ee, Onno Misset and Erik J. Baas (1997 Marcel Dekker, New York).

The lipid esterase may be selected from lipase enzymes in E.C. class 3.1 or 3.2 or a combination thereof.

Preferably the cleaning lipid esterases is selected from:
(1) Triacylglycerol lipases (E.C. 3.1.1.3)
(2) Carboxylic ester hydrolase (E.C. 3.1.1.1)
(3) Cutinase (E.C. 3.1.1.74)
(4) Sterol esterase (E.C. 3.1.1.13)
(5) Wax-ester hydrolase (E.C. 3.1.1.50)

Triacylglycerol lipases (E.C. 3.1.1.3) are most preferred.

Suitable triacylglycerol lipases can be selected from variants of the Humicola lanuginosa (Thermomyces lanuginosus) lipase. Other suitable triacylglycerol lipases can be selected from variants of Pseudomonas lipases, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), Bacillus lipases, e.g., from B. subtilis (Dartois et al. (1993), Biochemica et Biophysica Acta, 1131, 253-360), B. stearothermophilus (JP 64/744992) or B. pumilus (WO 91/16422).

Suitable carboxylic ester hydrolases can be selected from wild-types or variants of carboxylic ester hydrolases endogenous to B. gladioli, P. fluorescens, P. putida, B. acidocaldarius, B. subtilis, B. stearothermophilus, Streptomyces chrysomallus, S. diastatochromogenes and Saccharomyces cerevisiae.

Suitable cutinases can be selected from wild-types or variants of cutinases endogenous to strains of Aspergillus, in particular Aspergillus oryzae, a strain of Alternaria, in particular Alternaria brassiciola, a strain of Fusarium, in particular Fusarium solani, Fusarium solani pisi, Fusarium oxysporum, Fusarium oxysporum cepa, Fusarium roseum culmorum, or Fusarium roseum sambucinum, a strain of Helminthosporum, in particular Helminthosporum sativum, a strain of Humicola, in particular Humicola insolens, a strain of Pseudomonas, in particular Pseudomonas mendocina, or Pseudomonas putida, a strain of Rhizoctonia, in particular Rhizoctonia solani, a strain of Streptomyces, in particular Streptomyces scabies, a strain of Coprinopsis, in particular Coprinopsis cinerea, a strain of Thermobifida, in particular Thermobifida fusca, a strain of Magnaporthe, in particular Magnaporthe grisea, or a strain of Ulocladium, in particular Ulocladium consortiale.

In a preferred embodiment, the cutinase is selected from variants of the Pseudomonas mendocina cutinase described in WO 2003/076580 (Genencor), such as the variant with three substitutions at I178M, F180V, and S205G.

In another preferred embodiment, the cutinase is a wild-type or variant of the six cutinases endogenous to Coprinopsis cinerea described in H. Kontkanen et al, App. Environ. Microbiology, 2009, p 2148-2157.

In another preferred embodiment, the cutinase is a wild-type or variant of the two cutinases endogenous to Trichoderma reesei described in WO2009007510 (VTT).

In a most preferred embodiment the cutinase is derived from a strain of Humicola insolens, in particular the strain Humicola insolens DSM 1800. Humicola insolens cutinase is described in WO 96/13580 which is hereby incorporated by reference. The cutinase may be a variant, such as one of the variants disclosed in WO 00/34450 and WO 01/92502. Preferred cutinase variants include variants listed in Example 2 of WO 01/92502. Preferred commercial cutinases include Novozym 51032 (available from Novozymes, Bagsvaerd, Denmark).

Suitable sterol esterases may be derived from a strain of Ophiostoma, for example Ophiostoma piceae, a strain of Pseudomonas, for example Pseudomonas aeruginosa, or a strain of Melanocarpus, for example Melanocarpus albomyces.

In a most preferred embodiment the sterol esterase is the Melanocarpus albomyces sterol esterase described in H. Kontkanen et al, Enzyme Microb Technol., 39, (2006), 265-273.

Suitable wax-ester hydrolases may be derived from Simmondsia chinensis.

The lipid esterase is preferably selected from lipase enzyme in E.C. class 3.1.1.1 or 3.1.1.3 or a combination thereof, most preferably E.C.3.1.1.3.

Examples of EC 3.1.1.3 lipases include those described in WIPO publications WO 00/60063, WO 99/42566, WO 02/062973, WO 97/04078, WO 97/04079 and U.S. Pat. No. 5,869,438. Preferred lipases are produced by Absidia reflexa, Absidia corymbefera, Rhizmucor miehei, Rhizopus deleman Aspergillus niger, Aspergillus tubigensis, Fusa\acute{η}um oxysporum, Fusarium heterosporum, Aspergillus oryzea, Penicilium camembertii, Aspergillus foetidus, Aspergillus niger, Thermomyces lanoginosus (synonym: Humicola lanuginosa) and Landerina penisapora, particularly Thermomyces lanoginosus. Certain preferred lipases are supplied by Novozymes under the tradenames. Lipolase®, Lipolase Ultra®, Lipoprime®, Lipoclean® and Lipex® (registered tradenames of Novozymes) and LIPASE P “AMANO®” available from Areario Pharmaceutical Co. Ltd., Nagoya, Japan, AMANO-CES®, commercially available from Toyo Jozo Co., Tagata, Japan; and further Chromobacter viscosum lipases from Amersham Pharmacia Biotech., Piscataway, New Jersey, U.S.A. and Diosynth Co., Netherlands, and other lipases such as Pseudomonas gladioli. Additional useful lipases are described in WIPO publications WO 02062973, WO 2004/101759, WO 2004/101760 and WO 2004/101763. In one embodiment, suitable lipases include the “first cycle lipases” described in WO 00/60063 and U.S. Pat. No. 6,939,702 BI, preferably a variant of SEQ ID No. 2, more preferably a variant of SEQ ID No. 2 having at least 90% homology to SEQ ID No. 2 comprising a substitution of an electrically neutral or negatively charged amino acid with R or K at any of positions 3, 224, 229, 231 and 233, with a most preferred variant comprising T23 IR and N233R mutations, such most preferred variant being sold under the tradename Lipex® (Novozymes).

The aforementioned lipases can be used in combination (any mixture of lipases can be used). Suitable lipases can be purchased from Novozymes, Bagsvaerd, Denmark; Areario Pharmaceutical Co. Ltd., Nagoya, Japan; Toyo Jozo Co., Tagata, Japan; Amersham Pharmacia Biotech., Piscataway, New Jersey, U.S.A; Diosynth Co., Oss, Netherlands and/or made in accordance with the examples contained herein.

Lipid esterase with reduced potential for odour generation and a good relative performance, are particularly preferred, as described in WO 2007/087243. These include Lipoclean® (Novozyme).

Preferred commercially available lipase enzymes include Lipolase™ and Lipolase Ultra™ Lipex™ and Lipoclean™ (Novozymes A/S).

### Fragrances

Preferably, the fragrance comprises a component selected from the group consisting of ethyl-2-methyl valerate (manzanate), limonene, (4Z)-cyclopentadec-4-en-1-one, dihyro myrcenol, dimethyl benzyl carbonate acetate, benzyl acetate, spiro[1,3-dioxolane-2,5′-(4′,4′,8′,8′-tetramethyl-hexahydro-3′,9′-methanonaphthalene)], benzyl acetate, Rose Oxide, geraniol, methyl nonyl acetaldehyde, cyclacet (verdyl acetate), cyclamal, beta ionone, hexyl salicylate, tonalid, phenafleur, octahydrotetramethyl acetophenone (OTNE), the benzene, toluene, xylene (BTX) feedstock class such as 2-phenyl ethanol, phenoxanol and mixtures thereof, the cyclododecanone feedstock class, such as habolonolide, the phenolics feedstock class such as hexyl salicylate, the C5 blocks or oxygen containing heterocycle moiety feedstock class such as gamma decalactone, methyl dihydrojasmonate and mixtures thereof, the terpenes feedstock class such as dihydromycernol, linalool, terpinolene, camphor, citronellol and mixtures thereof, the alkyl alcohols feedstock class such as ethyl-2-methylbutyrate, the diacids feedstock class such as ethylene brassylate, and mixtures of these components.

Preferably, the fragrance comprises from 0.5 to 30% wt., more preferably from 2 to 15 wt. % and especially preferably from 6 to 10% wt. of the fragrance ethyl-2-methyl valerate (manzanate).

Preferably, the fragrance comprises from 0.5 to 30% wt., more preferably from 2 to 15% and especially preferably from 6 to 10% wt. of the fragrance (4Z)-cyclopentadec-4-en-1-one.

Preferably, the fragrance comprises from 0.5 to 30% wt., more preferably from 2 to 15% and especially preferably from 6 to 10% wt. of the fragrance dimethyl benzyl carbonate acetate.

Preferably, the fragrance comprises from 0.5 to 30% wt., more preferably from 2 to 15% and especially preferably from 6 to 10% wt. of the fragrance dihyromyrcenol.

Preferably, the fragrance comprises from 0.5 to 30% wt., more preferably from 2 to 15% and especially preferably from 6 to 10% wt. of the fragrance rose oxide.

Preferably, the fragrance comprises from 0.5 to 30% wt., more preferably from 2 to 15% and especially preferably from 6 to 10% wt. of the fragrance verdyl acetate.

Preferably, the fragrance comprises from 0.5 to 30% wt., more preferably from 2 to 15% and especially preferably from 6 to 10% wt. of the fragrance benzyl acetate.

Preferably, the fragrance comprises from 0.5 to 30% wt., more preferably from 2 to 15% and especially preferably from 6 to 10% wt. of the fragrance spiro[1,3-dioxolane-2,5′-(4′,4′,8′,8′-tetramethyl-hexahydro-3′,9′-methanonaphthalene)].

Preferably, the fragrance comprises from 0.5 to 30% wt., more preferably from 2 to 15% and especially preferably from 6 to 10% wt. of the fragrance geraniol.

Preferably, the fragrance comprises from 0.5 to 30% wt., more preferably from 2 to 15% and especially preferably from 6 to 10% wt. of the fragrance methyl nonyl acetaldehyde.

Preferably, the fragrance comprises from 0.5 to 30% wt., more preferably from 2 to 15% and especially preferably from 6 to 10% wt. of the fragrance cyclacet (verdyl acetate).

Preferably, the fragrance comprises from 0.5 to 30% wt., more preferably from 2 to 15% and especially preferably from 6 to 10% wt. of the fragrance cyclamal.

Preferably, the fragrance comprises from 0.5 to 30% wt., more preferably from 2 to 15 wt. % and especially preferably from 6 to 10% wt. of the fragrance beta ionone.

Preferably, the fragrance comprises from 0.5 to 30% wt., more preferably from 2 to 15 wt. % and especially preferably from 6 to 10% wt. of the fragrance hexyl salicylate.

Preferably, the fragrance comprises from 0.5 to 30% wt., more preferably from 2 to 15 wt. % and especially preferably from 6 to 10% wt. of the fragrance tonalid.

Preferably, the fragrance comprises from 0.5 to 30% wt., more preferably from 2 to 15 wt. % and especially preferably from 6 to 10% wt. of the fragrance phenafleur.

Preferably, the fragrance comprises a component selected from the benzene, toluene, xylene (BTX) feedstock class. More preferably, the fragrance component is selected from 2-phenyl ethanol, phenoxanol and mixtures thereof.

Preferably, the fragrance comprises a component selected from the cyclododecanone feedstock class. More preferably, the fragrance component is habolonolide.

Preferably, the fragrance comprises a component selected from the phenolics feedstock class. More preferably, the fragrance component is hexyl salicylate.

Preferably, the fragrance comprises a component selected from the C5 blocks or oxygen containing heterocycle moiety feedstock class. More preferably, the fragrance component is selected from gamma decalactone, methyl dihydrojasmonate and mixtures thereof.

Preferably, the fragrance comprises a component selected from the terpenes feedstock class. More preferably, the fragrance component is selected from, linalool, terpinolene, camphor, citronellol and mixtures thereof.

Preferably, the fragrance comprises a component selected from the alkyl alcohols feedstock class. More preferably, the fragrance component is ethyl-2-methylbutyrate.

Preferably, the fragrance comprises a component selected from the diacids feedstock class. More preferably, the fragrance component is ethylene brassylate.

Preferably, the fragrance comprises from 0.5 to 30% wt., more preferably from 2 to 15 wt. % and especially preferably from 6 to 10% wt. of the octahydrotetramethyl acetophenone (OTNE). OTNE is the abbreviation for the fragrance material with CAS numbers 68155-66-8, 54464-57-2 and 68155-67-9 and EC List number 915-730-3. Preferably the OTNE is present as a multi-constituent isomer mixture containing:
1-(1,2,3,4,5,6,7,8-octahydro-2,3,8,8-tetramethyl-2-naphthyl)ethan-1-one (CAS 54464-57-2)
1-(1,2,3,5,6,7,8,8a-octahydro-2,3,8,8-tetramethyl-2-naphthyl)ethan-1-one (CAS 68155-66-8)
1-(1,2,3,4,6,7,8,8a-octahydro-2,3,8,8-tetramethyl-2-naphthyl)ethan-1-one (CAS 68155-67-9)

Such OTNE and its method for manufacture is described fully in U.S. Pat. No. 3,907,321 (IFF).

The fragrance Molecule 01 is a specific isomer of OTNE, commercially available from IFF. Another commercially available fragrance Escentric 01 contains OTNE but also ambroxan, pink pepper, green lime with balsamic notes like benzoin mastic and incense.

Typically, commercially available fragrance raw materials comprise from 1 to 8% wt. of the fragrance raw material OTNE.

Preferably, the fragrance component listed above is present in the final detergent composition at from 0.0001 to 1% by wt. of the composition.

### Fluorescer

Preferably, the composition comprises a fluorescer. More preferably, the fluorescer comprises a sulphonated distyrylbiphenyl fluoscers such as those discussed in Chapter 7 of Industrial Dyes (K. Hunger ed, Wiley VCH 2003).

Sulfonated distyrylbiphenyl fluorescer are discussed in U.S. Pat. No. 5,145,991 (Ciba Geigy).

4,4′-distyrylbiphenyl are preferred. Preferably the fluorescer contains 2 SO₃⁻ groups.

Most preferably the fluorescer is of the structure:

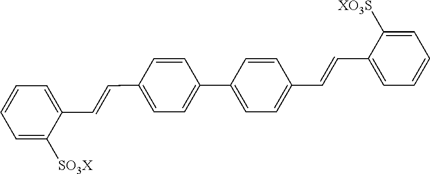

Where X is suitable counter ion, preferably selected from metal ions, ammonium ions, or amine salt ions, more preferably alkali metal ions, ammonium ions or amine salt ions, most preferably Na or K.

Preferably the fluoescer is present at levels of 0.01 wt % to 1 wt % of the composition, more preferably from 0.05 to 0.4 wt %., most preferably 0.11 to 0.3 wt %.

The C16 and/or C18 alkyl based surfactant, whether the alcohol ethoxylate or the alkyl ether sulphate is typically available as a mixture with C16 and C18 alkyl chain length raw material.

### Anti-Foam

The composition may also comprise an anti-foam but it is preferred that it does not. Anti-foam materials are well known in the art and include silicones and fatty acid.

Preferably, fatty acid soap is present at from 0 to 0.5% wt. of the composition (as measured with reference to the acid added to the composition), more preferably from 0 to 0.1% wt. and most preferably zero.

Suitable fatty acids in the context of this invention include aliphatic carboxylic acids of formula RCOOH, where R is a linear or branched alkyl or alkenyl chain containing from 6 to 24, more preferably 10 to 22, most preferably from 12 to 18 carbon atoms and 0 or 1 double bond. Preferred examples of such materials include saturated C12-18 fatty acids such as lauric acid, myristic acid, palmitic acid or stearic acid; and fatty acid mixtures in which 50 to 100% (by weight based on the total weight of the mixture) consists of saturated C12-18 fatty acids. Such mixtures may typically be derived from natural fats and/or optionally hydrogenated natural oils (such as coconut oil, palm kernel oil or tallow).

The fatty acids may be present in the form of their sodium, potassium or ammonium salts and/or in the form of soluble salts of organic bases, such as mono-, di- or triethanolamine.

Mixtures of any of the above described materials may also be used.

For formula accounting purposes, in the formulation, fatty acids and/or their salts (as defined above) are not included in the level of surfactant or in the level of builder.

Preferably, the composition comprises 0.2 to 10 wt % of the composition cleaning polymer.

Preferably, the cleaning polymer is selected from alkoxylate polyethylene imines, polyester soil release polymers and co-polymer of PEG/vinyl acetate.

### Preservative

Food preservatives are discussed In Food Chemistry (Belitz H.-D., Grosch W., Schieberle), 4th edition Springer.

The formulation contains a preservative or a mixture of preservatives, selected from benzoic acid and salts thereof, alkylesters of p-hydroxybenzoic acid and salts thereof, sorbic acid, diethyl pyrocarbonate, dimethyl pyrocarbonate, preferably benzoic acid and salts thereof, most preferably sodium benzoate.

An alternatively preferred preservative is selected from sodium benzoate, phenoxyethanol, dehydroacetaic acid and mixtures thereof.

The preservative is present at 0.1 to 3 wt %, preferably 0.3 wt % to 1.5 w %. Weights are calculated for the protonated form where appropriate.

Preferably, the composition comprises sodium benzoate at from 0.1 to 3 wt %, preferably 0.3 wt % to 1.5 w % of the composition.

Preferably, the composition comprises phenoxyethanol at from 0.1 to 3 wt %, preferably 0.3 wt % to 1.5 w % of the composition.

Preferably, the composition comprises dehydroacetic acid at from 0.1 to 3 wt %, preferably 0.3 wt % to 1.5 w % of the composition.

Preferably, the composition comprises less than 0.1% wt. isothiazolinone-based preservative, more preferably less than 0.05% wt.

### Soil Release Polymers

Soil release polymers help to improve the detachment of soils from fabric by modifying the fabric surface during washing. The adsorption of a SRP over the fabric surface is promoted by an affinity between the chemical structure of the SRP and the target fibre.

SRPs for use in the invention may include a variety of charged (e.g. anionic) as well as non-charged monomer units and structures may be linear, branched or star-shaped. The SRP structure may also include capping groups to control molecular weight or to alter polymer properties such as surface activity. The weight average molecular weight (M_{w}) of the SRP may suitably range from about 1000 to about 20,000 and preferably ranges from about 1500 to about 10,000.

SRPs for use in the invention may suitably be selected from copolyesters of dicarboxylic acids (for example adipic acid, phthalic acid or terephthalic acid), diols (for example ethylene glycol or propylene glycol) and polydiols (for example polyethylene glycol or polypropylene glycol). The copolyester may also include monomeric units substituted with anionic groups, such as for example sulfonated isophthaloyl units. Examples of such materials include oligomeric esters produced by transesterification/oligomerization of poly(ethyleneglycol) methyl ether, dimethyl terephthalate (“DMT”), propylene glycol (“PG”) and poly(ethyleneglycol) (“PEG”); partly- and fully-anionic-end-capped oligomeric esters such as oligomers from ethylene glycol (“EG”), PG, DMT and Na-3,6-dioxa-8-hydroxyoctanesulfonate; nonionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate.

Other types of SRP for use in the invention include cellulosic derivatives such as hydroxyether cellulosic polymers, C₁-C₄ alkylcelluloses and C₄ hydroxyalkyl celluloses; polymers with poly(vinyl ester) hydrophobic segments such as graft copolymers of poly(vinyl ester), for example C1-C₆ vinyl esters (such as poly(vinyl acetate)) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

Preferred SRPs for use in the invention include copolyesters formed by condensation of terephthalic acid ester and diol, preferably 1,2 propanediol, and further comprising an end cap formed from repeat units of alkylene oxide capped with an alkyl group. Examples of such materials have a structure corresponding to general formula (I):

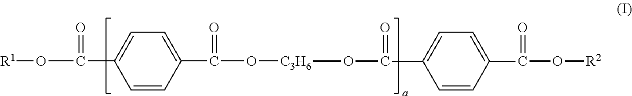

in which R¹ and R² independently of one another are X—(OC₂H₄)ₙ—(OC₃H₆)ₘ;
in which X is C₁₄ alkyl and preferably methyl;
n is a number from 12 to 120, preferably from 40 to 50;
m is a number from 1 to 10, preferably from 1 to 7; and
a is a number from 4 to 9.

Because they are averages, m, n and a are not necessarily whole numbers for the polymer in bulk.

Mixtures of any of the above described materials may also be used.

The overall level of SRP, when included, may range from 0.1 to 10%, depending on the level of polymer intended for use in the final diluted composition and which is desirably from 0.3 to 7%, more preferably from 0.5 to 5% (by weight based on the total weight of the diluted composition).

Suitable soil release polymers are described in greater detail in U.S. Pat. Nos. 5,574,179; 4,956,447; 4,861,512; 4,702,857, WO 2007/079850 and WO2016/005271. If employed, soil release polymers will typically be incorporated into the liquid laundry detergent compositions herein in concentrations ranging from 0.01 percent to 10 percent, more preferably from 0.1 percent to 5 percent, by weight of the composition.

### Hydrotropes

A composition of the invention may incorporate non-aqueous carriers such as hydrotropes, co-solvents and phase stabilizers. Such materials are typically low molecular weight, water-soluble or water-miscible organic liquids such as C1 to C5 monohydric alcohols (such as ethanol and n- or i-propanol); C2 to C6 diols (such as monopropylene glycol and dipropylene glycol); C3 to C9 triols (such as glycerol); polyethylene glycols having a weight average molecular weight (M_{w}) ranging from about 200 to 600; C1 to C3 alkanolamines such as mono-, di- and triethanolamines; and alkyl aryl sulfonates having up to 3 carbon atoms in the lower alkyl group (such as the sodium and potassium xylene, toluene, ethylbenzene and isopropyl benzene (cumene) sulfonates).

Mixtures of any of the above described materials may also be used.

Non-aqueous carriers, when included, may be present in an amount ranging from 0.1 to 3%, preferably from 0.5 to 1% (by weight based on the total weight of the composition). The level of hydrotrope used is linked to the level of surfactant and it is desirable to use hydrotrope level to manage the viscosity in such compositions. The preferred hydrotropes are monopropylene glycol and glycerol.

### Cosurfactants

A composition of the invention may contain one or more cosurfactants (such as amphoteric (zwitterionic) and/or cationic surfactants) in addition to the non-soap anionic and/or nonionic detersive surfactants described above.

Specific cationic surfactants include C8 to C18 alkyl dimethyl ammonium halides and derivatives thereof in which one or two hydroxyethyl groups replace one or two of the methyl groups, and mixtures thereof. Cationic surfactant, when included, may be present in an amount ranging from 0.1 to 5% (by weight based on the total weight of the composition).

Specific amphoteric (zwitterionic) surfactants include alkyl amine oxides, alkyl betaines, alkyl amidopropyl betaines, alkyl sulfobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms preferably selected from C12, C14, C16, C18 and C18:1, the term “alkyl” being used to include the alkyl portion of higher acyl radicals. Amphoteric (zwitterionic) surfactant, when included, may be present in an amount ranging from 0.1 to 5% (by weight based on the total weight of the composition).

Mixtures of any of the above described materials may also be used.

### Polymeric Thickeners

A composition of the invention may comprise one or more polymeric thickeners. Suitable polymeric thickeners for use in the invention include hydrophobically modified alkali swellable emulsion (HASE) copolymers. Exemplary HASE copolymers for use in the invention include linear or crosslinked copolymers that are prepared by the addition polymerization of a monomer mixture including at least one acidic vinyl monomer, such as (meth)acrylic acid (i.e. methacrylic acid and/or acrylic acid); and at least one associative monomer. The term “associative monomer” in the context of this invention denotes a monomer having an ethylenically unsaturated section (for addition polymerization with the other monomers in the mixture) and a hydrophobic section. A preferred type of associative monomer includes a polyoxyalkylene section between the ethylenically unsaturated section and the hydrophobic section. Preferred HASE copolymers for use in the invention include linear or crosslinked copolymers that are prepared by the addition polymerization of (meth)acrylic acid with (i) at least one associative monomer selected from linear or branched C₆-C₄₀ alkyl (preferably linear C₁₂-C₂₂ alkyl) polyethoxylated (meth)acrylates; and (ii) at least one further monomer selected from C₁-C₄ alkyl (meth) acrylates, polyacidic vinyl monomers (such as maleic acid, maleic anhydride and/or salts thereof) and mixtures thereof. The polyethoxylated portion of the associative monomer (i) generally comprises about 5 to about 100, preferably about 10 to about 80, and more preferably about 15 to about 60 oxyethylene repeating units.

Mixtures of any of the above described materials may also be used.

When included, a composition of the invention will preferably comprise from 0.01 to 5% wt. of the composition but depending on the amount intended for use in the final diluted product and which is desirably from 0.1 to 3% wt. by weight based on the total weight of the diluted composition.

### Shading Dyes

Shading dye can be used to improve the performance of the compositions. Preferred dyes are violet or blue. It is believed that the deposition on fabrics of a low level of a dye of these shades, masks yellowing of fabrics. A further advantage of shading dyes is that they can be used to mask any yellow tint in the composition itself.

Shading dyes are well known in the art of laundry liquid formulation.

Suitable and preferred classes of dyes include direct dyes, acid dyes, hydrophobic dyes, basic dyes, reactive dyes and dye conjugates. Preferred examples are Disperse Violet 28, Acid Violet 50, anthraquinone dyes covalently bound to ethoxylate or propoxylated polyethylene imine as described in WO2011/047987 and WO 2012/119859
alkoxylated mono-azo thiophenes, dye with CAS-No 72749-80-5, acid blue 59, and the phenazine dye selected from:

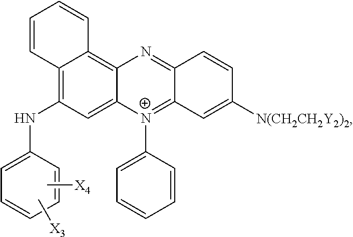

wherein:
X₃ is selected from: —H; —F; —CH₃; —C₂H₅; —OCH₃; and, —OC₂H₅;
X₄ is selected from: —H; —CH₃; —C₂H₅; —OCH₃; and, —OC₂H₅;
Y₂ is selected from: —OH; —OCH₂CH₂OH; —CH(OH)CH₂OH; —OC(O)CH₃; and, C(O)OCH₃.

Alkoxylated thiophene dyes are discussed in WO2013/142495 and WO2008/087497.

The shading dye is preferably present is present in the composition in range from 0.0001 to 0.1 wt %. Depending upon the nature of the shading dye there are preferred ranges depending upon the efficacy of the shading dye which is dependent on class and particular efficacy within any particular class.

### Microcapsules

One type of microparticle suitable for use in the invention is a microcapsule.

Microencapsulation may be defined as the process of surrounding or enveloping one substance within another substance on a very small scale, yielding capsules ranging from less than one micron to several hundred microns in size. The material that is encapsulated may be called the core, the active ingredient or agent, fill, payload, nucleus, or internal phase. The material encapsulating the core may be referred to as the coating, membrane, shell, or wall material. Microcapsules typically have at least one generally spherical continuous shell surrounding the core. The shell may contain pores, vacancies or interstitial openings depending on the materials and encapsulation techniques employed. Multiple shells may be made of the same or different encapsulating materials, and may be arranged in strata of varying thicknesses around the core. Alternatively, the microcapsules may be asymmetrically and variably shaped with a quantity of smaller droplets of core material embedded throughout the microcapsule.

The shell may have a barrier function protecting the core material from the environment external to the microcapsule, but it may also act as a means of modulating the release of core materials such as fragrance. Thus, a shell may be water soluble or water swellable and fragrance release may be actuated in response to exposure of the microcapsules to a moist environment. Similarly, if a shell is temperature sensitive, a microcapsule might release fragrance in response to elevated temperatures. Microcapsules may also release fragrance in response to shear forces applied to the surface of the microcapsules.

A preferred type of polymeric microparticle suitable for use in the invention is a polymeric core-shell microcapsule in which at least one generally spherical continuous shell of polymeric material surrounds a core containing the fragrance formulation (f2). The shell will typically comprise at most 20% by weight based on the total weight of the microcapsule. The fragrance formulation (f2) will typically comprise from about 10 to about 60% and preferably from about 20 to about 40% by weight based on the total weight of the microcapsule. The amount of fragrance (f2) may be measured by taking a slurry of the microcapsules, extracting into ethanol and measuring by liquid chromatography.

### Further Optional Ingredients

A composition of the invention may contain further optional ingredients to enhance performance and/or consumer acceptability. Examples of such ingredients include foam boosting agents, preservatives (e.g. bactericides), polyelectrolytes, anti-shrinking agents, anti-wrinkle agents, anti-oxidants, sunscreens, anti-corrosion agents, drape imparting agents, anti-static agents, ironing aids, colorants, pearlisers and/or opacifiers, and shading dye. Each of these ingredients will be present in an amount effective to accomplish its purpose. Generally, these optional ingredients are included individually at an amount of up to 5% (by weight based on the total weight of the diluted composition) and so adjusted depending on the dilution ratio with water.

In the second aspect there is provided a method for cleaning fabric comprising filling a reservoir of a washing machine with from 80 to 2000 ml of a liquid laundry detergent composition comprising C18-containing AE or AES where at least 10% wt. of the AE or AES comprises C18, and conducting at least two washing cycles before adding a further liquid detergent to the reservoir.

Preferably, the method comprises dosing at least 5 ml liquid laundry detergent into a wash liquor in a washing cycle. More preferably, the method comprises dosing at least 10 ml and most preferably at least 15 ml liquid laundry detergent.

The further liquid detergent may be the same or different to the initial laundry liquid composition but it is preferred that it is the same or substantially similar.

Preferably the further liquid laundry composition comprises C18-containing AE or AES where at least 10% wt. of the AE or AES comprises C18.

Preferably, the method comprises conducting at least five washing cycles before adding said further liquid detergent to the reservoir.

Preferably, each washing cycle comprises the drawing of a volume of liquid laundry detergent from the reservoir sufficient to form an appropriate wash liquor and to clean the fabric.

Preferably, this volume is from 10 to 75 ml but this is likely dependent on the amount of fabric, the stains to be cleaned and the amount of surfactant and other cleaning agents in the liquid laundry composition.

After the first washing cycle is completed, the remaining liquid detergent is maintained in the washing machine until the next cycle starts, when a further dose is pumped from the reservoir and mixed with water to form a wash liquor.

In a third aspect there is provided a method for cleaning fabric comprising filling a reservoir of a washing machine with from 80 to 3000 ml of a liquid laundry detergent composition comprising C18-containing AE or AES where at least 10% wt. of the AE or AES comprises C18, and conducting a washing cycle which draws a portion of the liquid detergent from the reservoir but leaves at least 20 ml in the reservoir.

Preferably, at least 30 ml is left in the reservoir after the washing cycle, more preferably at least 100 ml and most preferably at least 200 ml.

In a fourth aspect there is provided a method for cleaning a first fabric comprising filling a reservoir of a washing machine with from 80 ml to 3000 ml of a liquid detergent composition comprising C18-containing AE or AES where at least 10% wt. of the AE or AES comprises C18, and conducting a first washing cycle by forming a first wash liquor in the washing machine by drawing a portion of the liquid detergent from the reservoir and combining with water to form a first wash liquor and washing said first fabric;
optionally rinsing; and removing said first fabric from the washing machine; and
conducting a further wash cycle to clean a further fabric by drawing a portion of the liquid detergent from the reservoir and combining with water to form a further wash liquor and washing said further fabric;
optionally rinsing; and removing said further fabric from the washing machine;
optionally repeating the further wash cycle; and
adding a further liquid detergent to the reservoir.

Preferably, the further detergent comprises C18-containing AE or AES where at least 10% wt. of the AE or AES comprises C18,

But it may be a different liquid detergent.

### EXAMPLES

### Example 1

Liquid detergent formulation of the following composition was made:

TABLE 1

| | A | 1 |
|---|---|---|
| Ingredient | Wt % | Wt % |
| SAS | — | 9.9 |
| LAS | 9.9 | — |
| C16-18 Alcohol ethoxylate 9EO | 7.5 | 7.5 |
| Lauryl ether sulfate 3EO | 7.5 | 7.5 |
| Triethanolamine | 13.9 | 13.9 |
| Polyester soil release polymer | 0.5 | 0.5 |
| Monopropylene glycol | 3.2 | 3.2 |
| Polyamine cleaning polymer | 1.0/2.2 | 1.0/2.2 |
| HASE thickened polymer | 0.5 | 0.5 |
| Fatty acid | 1.4 | 1.4 |
| Citric acid | 1.6 | 1.6 |
| Dequest 2010 | 2.2 | 2.2 |
| Perfume | 1.2 | 1.2 |
| Total enzymes | 1.5 | 1.5 |
| Remainder water& minors | To 100% | To 100% |

### Example 2

Table 2 shows the performance of a formulation comprising C18 AE (1) and a formulation containing C12 AE (2) in the context of drying on exposure. The table shows that the composition comprising C18 AE loses less water than a formulation comprising C12 AE. This correlates with the finding that C18AE formulations perform better than C12 AE formulations when used in an auto-dosing context in that less evaporation of water over time while the laundry liquid is stored in a reservoir which is open to the environment between wash cycles.

In the test, the two formulations were exposed over a two week period and the amount of water lost was measured.

TABLE 2

| | T = 0 | | | T = 1 wk | | | T = 2 wks | | |
|---|---|---|---|---|---|---|---|---|---|
| | Wt (g) | Wt (g) | | Wt (g) | | | Wt (g) | | |
| | g | g | | g | | | g | | |
| | product | product + | | product + | g | % | product + | g | % |
| Formulation | added | beaker | beaker | beaker | evaporated | evaporated | beaker | evaporated | evaporated |
| 1 | 84.98 | 96.42 | 11.44 | 84.98 | 11.44 | 13% | 74.38 | 22.04 | 26% |
| 2 | 79.54 | 91.31 | 11.77 | 78.47 | 12.84 | 16% | 68.03 | 23.28 | 29% |

1. Washing machine comprising a detergent reservoir, said reservoir comprising from 80 ml to 3000 ml liquid detergent comprising C18-containing AE where at least 30% wt. of the AE comprises C18 and wherein the detergent composition comprises at least 50% wt. water.

2. A washing machine according to claim 1 comprising from 250 to 2500 ml liquid detergent.

3. A washing machine according to claim 1 comprising from 400 to 2000 ml liquid detergent.

4. Washing machine according to claim 1 wherein the liquid detergent comprises from 0.1 to 3% wt. alkoxylated polyamine.

5. Washing machine according to claim 1 wherein the liquid detergent comprises from 0.1 to 3% wt. aminocarboxylate and mixtures thereof.

6. Washing machine according to claim 1 wherein the liquid detergent comprises from 0.1 to 5% wt. external structurant.

7. Washing machine according to claim 1 wherein the liquid detergent comprises from 5 to 30% wt. C18-containing AE.

8. A method for cleaning fabric comprising filling a reservoir of a washing machine with from 80 to 3000 ml of a liquid laundry detergent composition comprising C18-containing AE where at least 30% wt. of the AE comprises C18 and wherein the detergent composition comprises at least 50% wt. water,
and conducting a washing cycle which draws a portion of the liquid detergent from the reservoir but leaves at least 20 ml in the reservoir.

9. A method for cleaning fabric comprising filling a reservoir of a washing machine with from 80 to 3000 ml of a liquid laundry detergent composition comprising C18-containing AE where at least 30% wt. of the AE comprises C18, and wherein the detergent composition comprises at least 50% wt. water,
and conducting at least two washing cycles before adding a further liquid detergent to the reservoir.

10. A method for cleaning a first fabric comprising filling a reservoir of a washing machine with from 80 ml to 3000 ml of a liquid detergent composition comprising C18-containing AE where at least 30% wt. of the AE comprises C18 and wherein the detergent composition comprises at least 50% wt. water,
and conducting a first washing cycle by forming a first wash liquor in the washing machine by drawing a portion of the liquid detergent from the reservoir and combining with water to form a first wash liquor and washing said first fabric;
optionally rinsing; and removing said first fabric from the washing machine; and
conducting a further wash cycle to clean a further fabric by drawing a portion of the liquid detergent from the reservoir and combining with water to form a further wash liquor and washing said further fabric;
optionally rinsing; and removing said further fabric from the washing machine;
optionally repeating the further wash cycle; and
adding a further liquid detergent to the reservoir.
